(19) United States
(12) Patent Application Publication
(10) Pub. No.: US 2017/0127505 A1
(43) Pub. Date: May 4, 2017

(54) EXTREME ULTRAVIOLET LIGHT GENERATION SYSTEM AND EXTREME ULTRAVIOLET LIGHT GENERATION METHOD

(71) Applicants: Institute for Laser Technology, Osaka (JP); Gigaphoton Inc., Tochigi (JP)

(72) Inventors: Atsushi SUNAHARA, Osaka-shi (JP); Georg SOUMAGNE, Oyama-shi (JP); Yoshifumi UENO, Oyama-shi (JP); Hideo HOSHINO, Oyama-shi (JP)

(73) Assignees: Institute for Laser Technology, Osaka (JP); Gigaphoton Inc., Tochigi (JP)

(21) Appl. No.: 15/400,116

(22) Filed: Jan. 6, 2017

Related U.S. Application Data
(63) Continuation of application No. PCT/JP2014/071872, filed on Aug. 21, 2014.

(51) Int. Cl. H05G 2/00

(52) U.S. Cl. CPC H05G 2/008

(57) ABSTRACT

An extreme ultraviolet light generation system may comprise a chamber, a target supply unit configured to supply, to a predetermined region in the chamber, a target having an atomic density of 8.0×10¹⁷ atoms/cm³ or higher and 1.3×10¹⁸ atoms/cm³ or lower, and a laser apparatus configured to irradiate the predetermined region with a pulse laser beam having an energy density of 10.5 J/cm² or higher and 52.3 J/cm² or lower in the predetermined region.

### TECHNICAL FIELD

The present disclosure relates to an extreme ultraviolet light generation system and an extreme ultraviolet light generation method.

### BACKGROUND ART

In recent years, as semiconductor processes become finer, transfer patterns for use in photolithographies of semiconductor processes have rapidly become finer. In the next generation, microfabrication at 70 nm to 45 nm, and further, microfabrication at 32 nm or less would be demanded. In order to meet the demand for, for example, microfabrication at 32 nm or less, it is expected to develop an exposure apparatus in which a system for generating extreme ultraviolet (EUV) light at a wavelength of approximately 13 nm is combined with a reduced projection reflective optical system.

Three types of EUV light generation systems have been proposed, which include an LPF (laser produced plasma) type system using plasma generated by irradiating a target material with a pulse laser beam, a DPP (discharge produced plasma) type system using plasma generated by an electric discharge, and an SR (synchrotron radiation) type system using synchrotron radiation.

### SUMMARY

An extreme ultraviolet light generation system according to an aspect of the present disclosure may include: a chamber; a target supply unit configured to supply, to a predetermined region in the chamber, a target having an atomic density of 8.0×10¹⁷ atoms/cm³ or higher and 1.3×10¹⁸ atoms/cm³ or lower; and a laser apparatus configured to irradiate the predetermined region with a pulse laser beam having an energy density of 10.5 J/cm² or higher and 52.3 J/cm² or lower in the predetermined region.

An extreme ultraviolet light generation method according to another aspect of the present disclosure may include: supplying, to a predetermined region in a chamber, a target having an atomic density of 8.0×10¹⁷ atoms/cm³ or higher and 1.3×10¹⁸ atoms/cm³ or lower; and irradiating the predetermined region with a pulse laser beam having an energy density of 10.5 J/cm² or higher and 52.3 J/cm³ or lower in the predetermined region.

### BRIEF DESCRIPTION OF THE DRAWINGS

Selected embodiments of the present disclosure will be described below with reference to the accompanying drawings by way of example.

FIG. 1 schematically illustrates an exemplary configuration of an LPP type EUV light generation system.

FIG. 2 illustrates a simulation model of a two-dimensional Euler radiative fluid dynamics code RZLINE that the Applicant used in simulations.

FIG. 3A shows an example of a result of a simulation of conversion efficiency.

FIG. 3B shows an example of a result of another simulation of conversion efficiency.

FIG. 4 is a graph showing a result of still another simulation of conversion efficiency with changes in atomic density of a target material.

FIG. 5 is a partial cross-sectional view schematically illustrating an exemplary configuration of an EUV light generation system according to a first embodiment.

FIG. 6 is a partial cross-sectional view schematically illustrating an exemplary configuration of an EUV light generation system according to a second embodiment.

FIG. 7 specifically illustrates a configuration of an optical path adjuster shown in FIG. 6.

FIGS. 8A and 8B show a relationship between wavelengths of pulse laser beams outputted from master oscillators shown in FIG. 6, gains of amplifiers, and light intensities.

FIG. 9 is a timing chart of outputting pulse laser beams in a main pulse laser device shown in FIG. 6.

FIG. 10 schematically illustrates a configuration of one of the master oscillators shown in FIG. 6.

FIG. 11 illustrates a configuration of an aerosol supply device shown in FIG. 6, together with the other components of the EUV light generation system.

FIG. 12A schematically illustrates an exemplary configuration of a powder output unit shown in FIG. 6.

FIG. 12B shows dimensions of components of a designed aerodynamic lens.

FIG. 13 is a conceptual diagram illustrating an example of a corrective optical element.

FIG. 14 is a conceptual diagram illustrating another example of the corrective optical element.

FIG. 15 is a conceptual diagram illustrating still another example of the corrective optical element.

FIG. 16 is a conceptual diagram illustrating still another example of the corrective optical element.

FIG. 17 schematically illustrates a configuration of a main pulse laser device used in an EUV light generation system according to a third embodiment.

FIG. 18 schematically illustrates a first exemplary configuration of a pulse picker shown in FIG. 17.

FIG. 19 shows a relationship between a voltage applied to a Pockels cell and a pulse laser beam.

FIG. 20 schematically illustrates a second exemplary configuration of the pulse picker shown in FIG. 17.

FIG. 21 schematically illustrates the second exemplary configuration of the pulse picker shown in FIG. 17.

FIG. 22 schematically illustrates a configuration of a main pulse laser device used in an EUV light generation system according to a fourth embodiment.

FIG. 23 schematically illustrates a configuration of a main pulse laser device used in an EUV light generation system according to a fifth embodiment.

### EMBODIMENTS

### Contents

### 1. Overview

### 2. Description of Terms

### 3. Overview of Extreme Ultraviolet Light Generation System

3.1 Configuration
3.2 Operation

### 4. Simulation Results

5. EUV Light Generation System in Which Low-density Target is Irradiated with Pulse Laser Beam
5.1 EUV Light Generation Apparatus
5.2 Laser Apparatus

### 6. EUV Light Generation System That Emits Pulse Laser Beams at High Repetition Rate

6.1 Overview
6.2 Details of Laser Device
   6.2.1 Master Oscillators
   6.2.2 Optical Path Adjuster
   6.2.3 Relationship between Wavelengths of Pulse Laser Beams and Gains of Amplifiers
   6.2.4 Moderating Gain Reduction
   6.2.5 Example of Master Oscillator (Quantum-cascade Laser)
6.3 Target Supply Unit That Supplies Powder Target
   6.3.1 Aerosol Generator
   6.3.2 Configuration of Aerodynamic Lens
   6.3.3 Exemplary Design of Aerodynamic Lens
6.4 Corrective Optical Element

### 7. Modification of Laser Device (Third Embodiment)

7.1 Master Oscillator
7.2 Pulse Picker
7.3 Regenerative Amplifier

### 8. Modification of Laser Device (Fourth Embodiment)

### 9. Modification of Laser Device (Fifth Embodiment)

Selected embodiments of the present disclosure will be described in detail below with reference to the accompanying drawings. The embodiments to be described below are merely illustrative in nature and do not limit the scope of the present disclosure. Further, configuration(s) and operation(s) described in each embodiment are not all essential in implementing the present disclosure. Corresponding elements may be referenced by corresponding reference symbols, and duplicate descriptions thereof may be omitted.

### 1. Overview

In an LPP type EUV light generation apparatus, a target may be supplied from a target supply unit, and a pulse laser beam outputted from a laser apparatus may be focused on the target, whereby the target may be turned into plasma. From the plasma, rays of light including EUV light may be emitted. The EUV light thus emitted may be collected by an EUV collector mirror and outputted to an exposure apparatus or the like.

In an EUV light generation apparatus prepared so far by the Applicant, conversion efficiency (SE) from the energy of a pulse laser beam into the energy of EUV light is approximately 2.5%, and a basic experiment conducted by the Applicant demonstrates that approximately 4% can be achieved. For example, assuming that the conversion efficiency is 2.5%, the output intensity of a pulse laser beam needs to be 40 kW in order to achieve an EUV light output of 200 W.

The Applicant has found through a simulation that an improvement in conversion efficiency can be achieved when the target density is approximately 1.3×10¹⁸ atoms/cm³ and the energy density of one pulse of the pulse laser beam at a target irradiation position is approximately 35.4 J/cm². According to this finding, a larger EUV light output is expected to be achieved with smaller energy.

### 2. Description of Terms

A “pulse laser beam” may refer to a laser beam including a plurality of pulses.

A “target material” may refer to a material, such as tin (Sn), gadolinium (Gd), or terbium (Tb), which may be turned into plasma by being irradiated with at least one pulse of the pulse laser beam to emit EUV light from the plasma.

A “target” may refer to a mass, containing a small amount of the target material, which is supplied into the chamber by the target supply unit and irradiated with the pulse laser beam. This mass can be in the form of a solid, powder, liquid, or gas.

A “powder target” may refer to a target containing a plurality of fine solid particles,

An “aerosol” may refer to a dispersion system in which the fine solid particles are suspended within a gas.

A “plasma generation region” may refer to a region where generation of the plasma is started by irradiating the target with the pulse laser beam. The plasma generation region may correspond to a predetermined region in the present disclosure.

### 3. Overview of Extreme Ultraviolet Light Generation System

3.1 Configuration

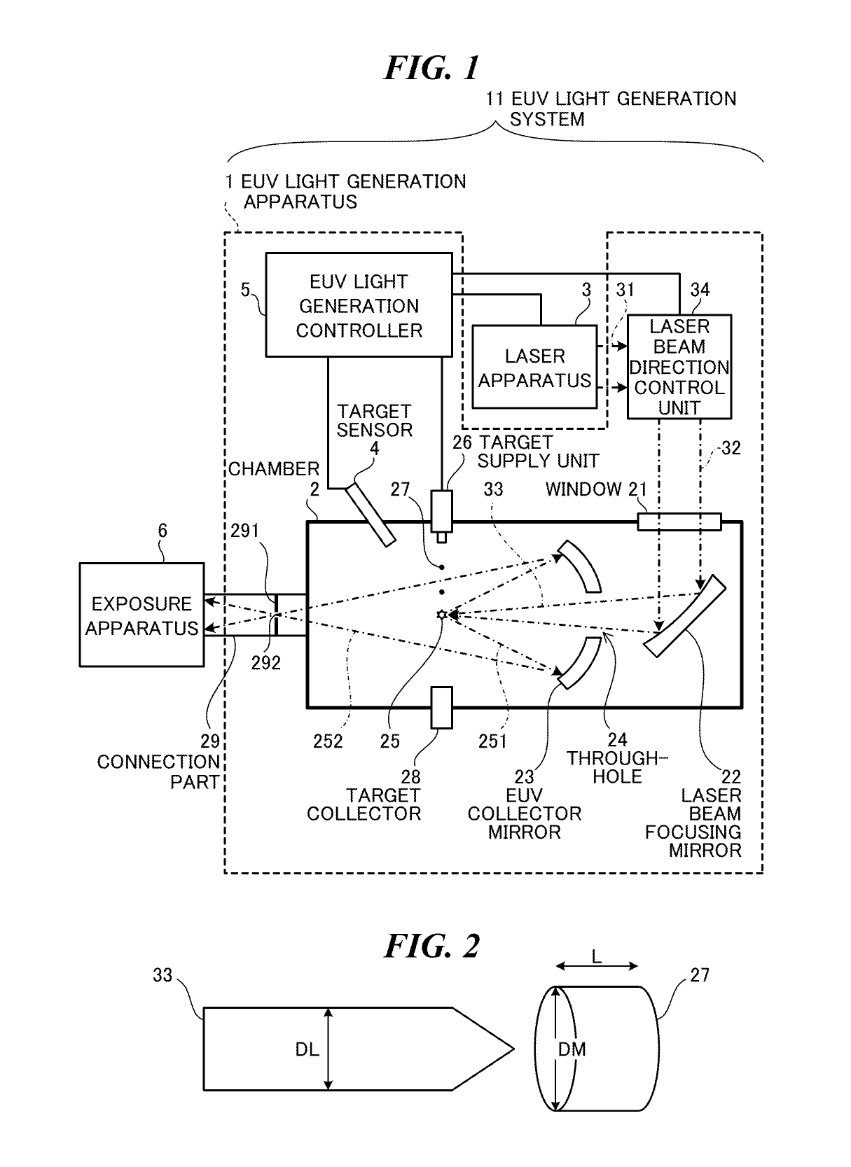

FIG. 1 schematically illustrates an exemplary configuration of an LPP type EUV light generation system. An EUV light generation apparatus 1 may be used with at least one laser apparatus 3. In the present disclosure, a system that includes the EUV light generation apparatus 1 and the laser apparatus 3 may be referred to as an EUV light generation system 11. As shown in FIG. 1 and described in detail below, the EUV light generation apparatus 1 may include a chamber 2 and a target supply unit 26. The chamber 2 may be sealed airtight. The target supply unit 26 may be mounted onto the chamber 2, for example, to penetrate a wall of the chamber 2. A target material to be supplied by the target supply unit 26 may include, but is not limited to, tin, terbium, gadolinium, lithium, or a combination of any two or more of them.

The chamber 2 may have at least one through-hole formed in its wall. A window 21 may be located at the through-hole. A pulse laser beam 32 outputted from the laser apparatus 3 may travel through the window 21. In the chamber 2, an EUV collector mirror 23 having a spheroidal reflective surface, for example, may be provided. The EUV collector mirror 23 may have a first focusing point and a second focusing point. The surface of the EUV collector mirror 23 may have, for example, a multi-layered reflective film in which molybdenum layers and silicon layers are alternately laminated. Preferably the EUV collector mirror 23 is, for example, positioned such that the first focusing point is positioned in a plasma generation region 25 and the second focusing point is positioned in an intermediate focus (IF) region 292. The EUV collector mirror 23 may have a through-hole 24 formed at the center thereof, and a pulse laser beam 33 may travel through the through-hole 24.

The EUV light generation apparatus 1 may further include an EUV light generation controller 5 and a target sensor 4. The target sensor 4 may have an imaging function and detect the presence, actual path, position, speed, and the like of a target 27,

Furthermore, the EUV light generation apparatus 1 may include a connection part 29 for allowing the interior of the chamber 2 to be in communication with the interior of the exposure apparatus 6. In the connection part 29, a wall 291 formed with an aperture may be provided. The wall 291 may be positioned such that the second focusing point of the EUV collector mirror 23 lies in the aperture formed in the wall 291.

Furthermore, the EUV light generation apparatus 1 may also include a laser beam direction control unit 34, a laser beam focusing mirror 22, a target collector 28 for collecting the target 27, and the like. The laser beam direction control unit 34 may include an optical system for defining the traveling direction of the pulse laser beam and an actuator for adjusting the position, the posture, or the like of the optical system.

3.2 Operation

With continued reference to FIG. 1, a pulse laser beam 31 outputted from the laser apparatus 3 may pass through the laser beam direction control unit 34 and be outputted therefrom as the pulse laser beam 32. The pulse laser beam 32 may travel through the window 21 and enter the chamber 2. The pulse laser beam 32 may travel inside the chamber 2 along at least one laser optical path, be reflected by the laser beam focusing mirror 22, and strike the target 27 as the pulse laser beam 33.

The target supply unit 26 may be configured to output the target 27 toward the plasma generation region 25 in the chamber 2. The target 27 may be irradiated with at least one pulse of the pulse laser beam 33. Upon being irradiated with the pulse laser beam 33, the target 27 may be turned into plasma, and rays of light 251 may be emitted from the plasma. EUV light included in the light 251 may be reflected by the EUV collector mirror 23 at higher reflectance than light in other wavelength region. EUV light 252 including the EUV light reflected by the EUV collector mirror 23 may be focused in the intermediate focus region 292 and outputted to the exposure apparatus 6.

The EUV light generation controller 5 may be configured to integrally control the EUV light generation system 11. The EUV light generation controller 5 may be configured to process, for example, image data of the target 27 as captured by the target sensor 4. Further, the EUV light generation controller 5 may be configured to control the timing when the target 27 is outputted, the direction in which the target 27 is outputted, and the like. Furthermore, the EUV light generation controller 5 may, for example, be configured to control the timing when the laser apparatus 3 oscillates, the traveling direction in which the pulse laser beam 32 travels, the position at which the pulse laser beam 33 is focused, and the like. The various controls mentioned above are merely examples, and other controls may be added as necessary.

### 4. Simulation Results

FIG. 2 illustrates a simulation model of a two-dimensional Euler radiative fluid dynamics code RZLINE that the Applicant used in simulations. In this simulation model, it may be assumed that the target 27 having a predetermined shape and a predetermined density is irradiated with the pulse laser beam 33. It may be assumed that a distribution profile of the target 27 has a cylindrical shape.

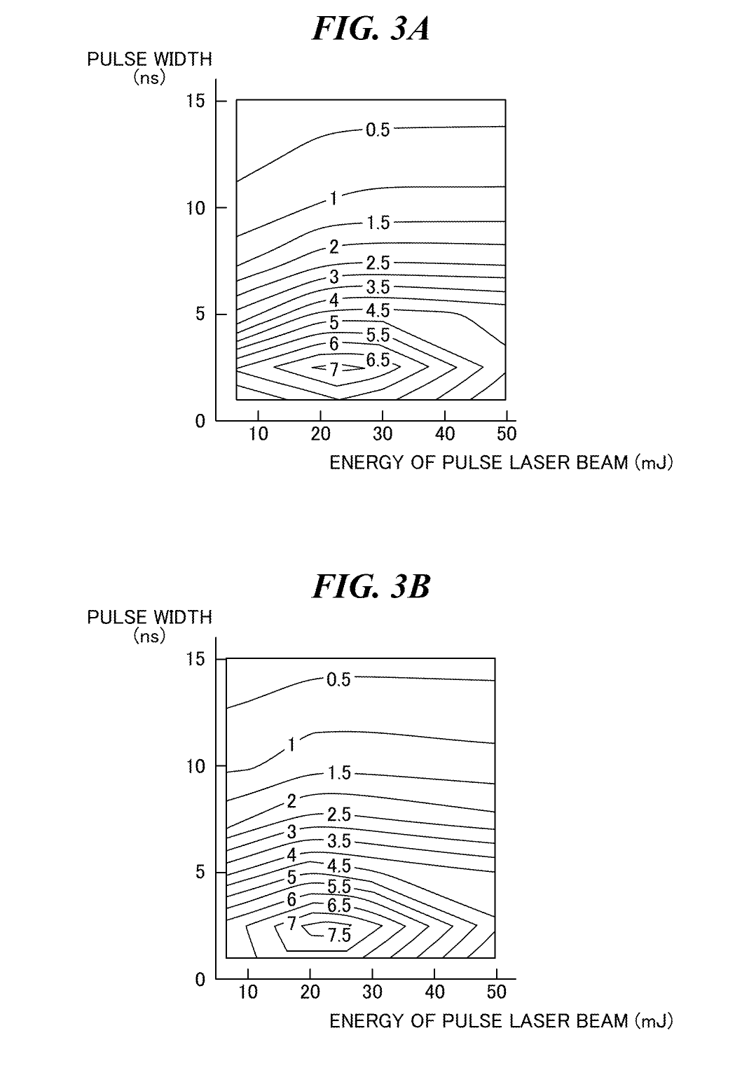

FIGS. 3A and 3B show examples of results of the simulations of conversion efficiency. In FIGS. 3A and 3B, the simulations of the conversion efficiency according to various energies and pulse widths of the pulse laser beam were performed under the following conditions. The diameter DM of the target was 400 μm, and the thickness L of the target was 150 μm. The atomic density of the target material was uniformly 1×10¹⁸ atoms/cm³. The beam diameter DL of the pulse laser beam was 300 μm at a portion having an intensity of 1/e² or higher of the peak value. FIG. 3A shows a simulation result obtained in a case where the light intensity distribution of the pulse laser beam is a Gaussian distribution, and FIG. 3B shows a simulation result obtained in a case where the light intensity distribution of the pulse laser beam is a top-hat distribution. The top-hat distribution means that the light intensity distribution of the pulse laser beam is uniform in a cross-section of the beam. A calculation of the energy density of the pulse laser beam is based on a value obtained by dividing the pulse energy of the laser beam by the area of the cross-section of the laser beam. Further, the pulse width is calculated as the full width at half maximum.

In the case where the light intensity distribution of the pulse laser beam is the Gaussian distribution, it may be suggested from FIG. 3A that the conversion efficiency is approximately 6% under the following preferable conditions:

The energy of one pulse of the pulse laser beam is in a range of 7.4 mJ or higher and 37.0 mJ or lower, and the pulse width of the pulse laser beam is in a range of 1.0 ns or more and 3.7 ns or less.

Based on the energy range and the beam diameter of the pulse laser beam, the energy density of the pulse laser beam may be calculated to be 10.5 J/cm² or higher and 52.3 J/cm² or lower.

More preferably, conditions under which the conversion efficiency is 7% or higher are as follows:

The energy of one pulse of the pulse laser beam is in a range of 18.5 mJ or higher and 28.0 mJ or lower, and the pulse width of the pulse laser beam is in a range of 2.3 ns or more and 2.6 ns or less.

Based on the energy range and the beam diameter of the pulse laser beam, the energy density of the pulse laser beam may be calculated to be 26.2 J/cm² or higher and 40.0 J/cm² or lower.

In the case where the light intensity distribution of the pulse laser beam is the top-hat distribution, it may be suggested from FIG. 3B that the conversion efficiency is approximately 7.5% under the following conditions:

The energy of one pulse of the pulse laser beam is in a range of 18.0 mJ or higher and 27.0 mJ or lower, and the pulse width of the pulse laser beam is in a range of 2.0 ns or more and 2.6 ns or less.

Based on the energy range and the beam diameter of the pulse laser beam, the energy density of the pulse laser beam may be calculated to be 25.5 J/cm² or higher and 38.2 J/cm² or lower.

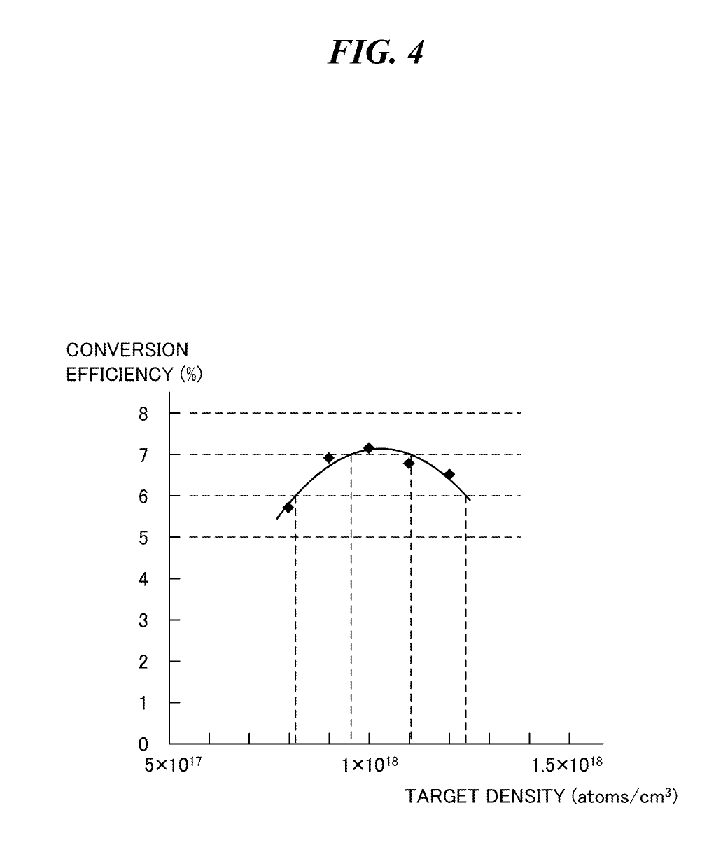

FIG. 4 is a graph showing a simulation result of conversion efficiency with changes in atomic density of the target material. In FIG. 4, the energy and the pulse width of one pulse of the pulse laser beam are fixed at 25 mJ and 2.5 ns, respectively, with changes in atomic density of the target material. The other conditions were the same as those in FIG. 3A. The dots in the graph indicate values obtained by the simulation, and the curve indicates a polynominal approximate curve derived from the values obtained by the simulation.

From the result shown in FIG. 4, the atomic density of the target material may preferably fall within the range of being 8.0×10¹⁷ atoms/cm³ or higher and 1.3×10¹⁸ atoms/cm³ or lower.

More preferably, the atomic density of the target material may fall within the range of being 9.5×10¹⁷ atoms/cm³ or higher and 1.1×10¹⁸ atoms/cm³ or lower.

### 5. EUV Light Generation System that Irradiates Low-Density Target with Pulse Laser Beam

5.1 EUV Light Generation Apparatus

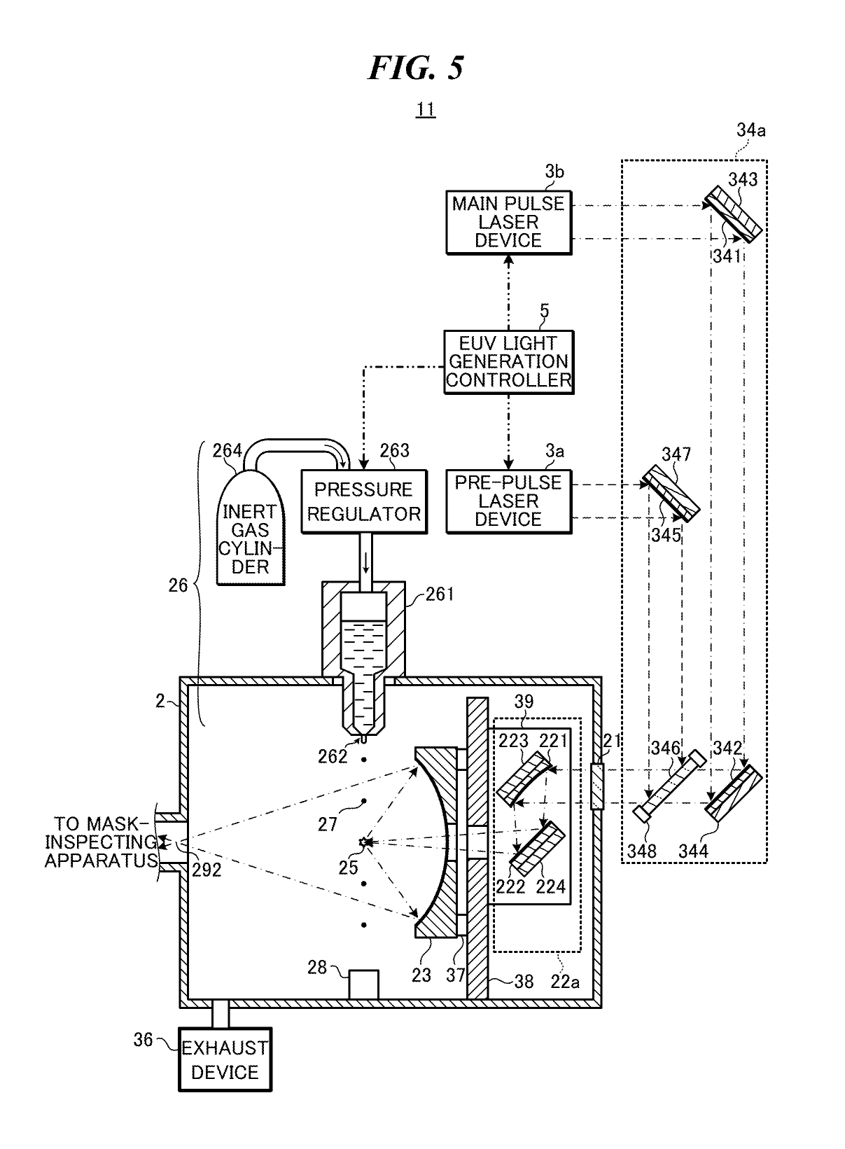

FIG. 5 is a partial cross-sectional view schematically illustrating an exemplary configuration of an EUV light generation system 11 according to a first embodiment. As shown in FIG. 5, the EUV collector mirror 23, the target collector 28, and an EUV collector mirror holder 37 may be provided within the chamber 2.

The EUV collector mirror 23 may be fixed to the chamber 2 via the EUV collector mirror holder 37. The target collector 28 may be disposed on an extension line of a trajectory of the targets 27, and collect those of the targets 27 which were not irradiated with the pulse laser beam.

A laser beam focusing optical system 22a may further be provided within the chamber 2. The laser beam focusing optical system 22a may include an off-axis paraboloidal mirror 221 and a flat mirror 222. The off-axis paraboloidal mirror 221 may be supported by a holder 223. The flat mirror 222 may be supported by a holder 224. The holders 223 and 224 may be fixed to a plate 39. The plate 39 may be fixed to a plate 38. The EUV collector mirror 23 may be fixed to the plate 38 via the EUV collector mirror holder 37. The plate 38 may be fixed to the chamber 2. The laser beam focusing optical system 22a may focus, onto the plasma generation region 25, a pulse laser beam outputted from the laser apparatus including a pre-pulse laser device 3a and a main pulse laser device 3b.

The target supply unit 26 and an exhaust device 36 may be mounted to the chamber 2. The exhaust device 36 may be a pump which exhausts gases from the chamber 2 so that the pressure inside the chamber 2 may be kept to a predetermined pressure lower than the atmospheric pressure. The target supply unit 26 may include a reservoir 261, a pressure regulator 263, and an inert gas cylinder 264,

The reservoir 261 may be fixed to the chamber 2. In the reservoir 261 a target material containing, for example, tin may be stored in a molten state. A heater (not illustrated) may be attached to the reservoir 261 to keep the target material in the molten state.

The inert gas cylinder 264 may be connected to the pressure regulator 263 through a pipe. The pressure regulator 263 may communicate with the inside of the reservoir 261 through another pipe. An inert gas may be supplied from the inert gas cylinder 264 into the reservoir 261 through these pipes. The inert gas introduced into the reservoir 261 may pressurize the molten target material stored in the reservoir 261. By the inert gas pressurizing the target material, a jet of the target material in liquid form may exit from a nozzle 262 of the reservoir 261.

A vibrating element (not illustrated) may be attached to the nozzle 262. The vibrating element may impart vibration to the nozzle 262. The vibration imparted to the nozzle 262 may cause the jet of the target material from the nozzle 262 to be separated and to change into a plurality of droplet targets 27. The targets 27 outputted into the chamber 2 may be supplied to the plasma generation region 25 in the chamber 2. The repetition frequency of the generation of the droplet targets 27 may be approximately 1 Hz to 100 kHz.

5.2 Laser Apparatus

The laser apparatus disposed outside of the chamber 2 may include the pre-pulse laser device 3a and the main pulse laser device 3b.

The pre-pulse laser device 3a may, for example, be a solid-state laser device that outputs a pulse laser beam at a wavelength of approximately 1 μm. For example, the pre-pulse laser device 3a may be constituted by a laser device including a YAG crystal. The pre-pulse laser device 3a may output the pre-pulse laser beam with which the droplet target 27 is irradiated.

The EUV light generation controller 5 may control the pre-pulse laser device 3a so that the plasma generation region 25 is irradiated with the pre-pulse laser beam at a time when the target 27 reaches the plasma generation region 25.

Irradiation of the target 27 with the pre-pulse laser beam may cause the target 27 to be destructed and dispersed, partially evaporated, or partially ionized to generate a secondary target. This may cause the atomic density of the target material in the plasma generation region 25 to be 8.0×10¹⁷ atoms/cm³ or higher and 1.3×10¹⁸ atoms/cm³ or lower at a certain time after the irradiation with the pre-pulse laser beam. To achieve such an atomic density, one target 27 may be irradiated with the pre-pulse laser beam twice or more to generate the secondary target.

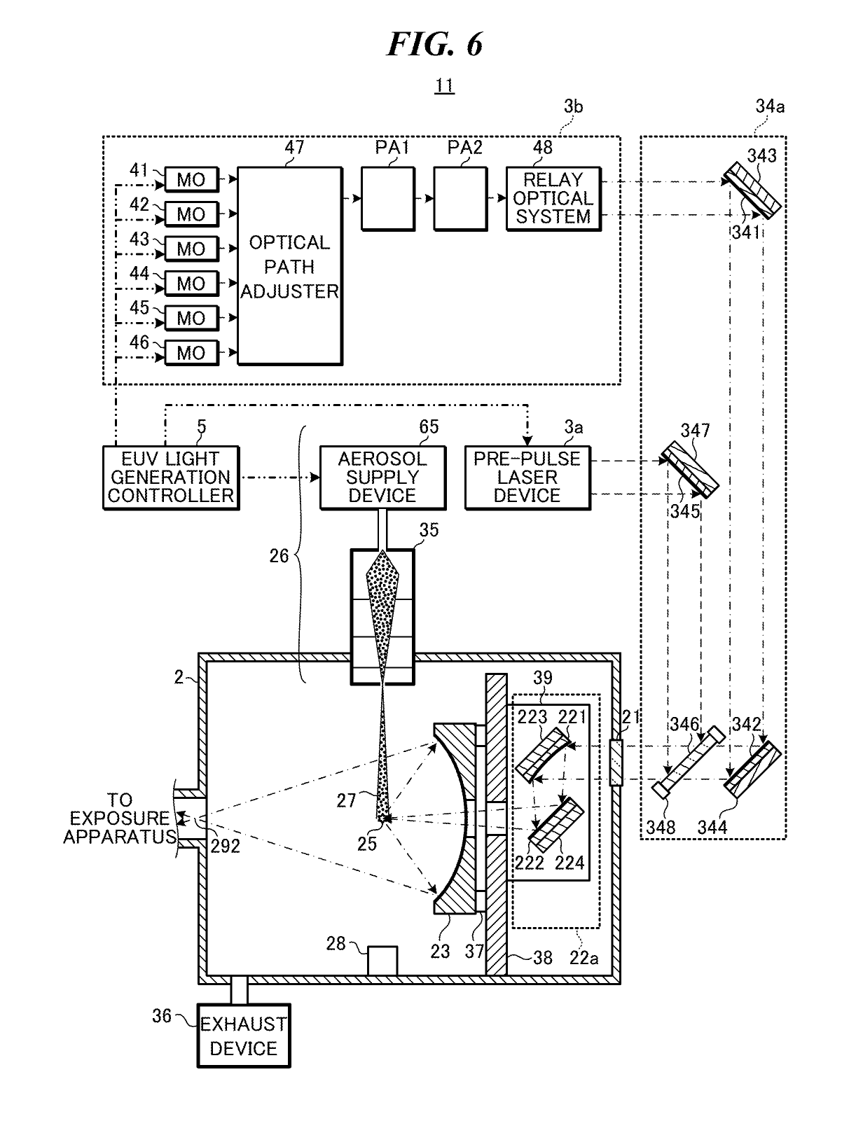

The main pulse laser device 3b may be constituted, for example, by a CO₂ laser device that outputs a pulse laser beam at a wavelength of approximately 10.6 μm. The main pulse laser device 3b may include a master oscillator and a plurality of amplifiers (not illustrated). The main pulse laser device 3b may output a main pulse laser beam, with which the secondary target whose atomic density has been brought into a predetermined range by the pre-pulse laser beam is irradiated. The main pulse laser device 3b may employ a configuration of a main pulse laser device described below with reference to FIGS. 6 to 10 according to a second embodiment.

The EUV light generation controller 5 may control the main pulse laser device 3b so that the plasma generation region 25 is irradiated with the main pulse laser beam at a certain time after the irradiation of the target 27 with the pre-pulse laser beam.

Preferably, the energy density of the main pulse laser beam may be 10.5 J/cm² or higher and 52.3 J/cm² or lower. The pulse width of the main pulse laser beam may be 1.0 ns or more and 3.7 ns or less.

More preferably, the energy density of the main pulse laser beam may be 26.2 J/cm² or higher and 40.0 J/cm² or lower. The pulse width of the main pulse laser beam may be 2.0 ns or more and 2.6 ns or less.

By irradiating the secondary target having an atomic density of 8.0×10¹⁷ atoms/cm³ or higher and 1.3×10¹⁸ atoms/cm³ or lower with the main pulse laser beam, the target material may turn into plasma.

The repetition frequency of the main pulse laser beam may be approximately 1 Hz to 1.00 kHz. In this case, the output of the EUV light may be approximately several milliwatts to several tens of watts. With this, for example, an output of the EUV light that is sufficient to be utilized as a light source in an apparatus for inspecting a mask for EUV exposure or an apparatus for inspecting an optical element for EUV light may be obtained with high conversion efficiency.

### 6, EUV Light Generation System that Emits Pulse Laser Beams at High Repetition Frequency

6.1 Overview

FIG. 6 is a partial cross-sectional view schematically illustrating an exemplary configuration of an EUV light generation system 11 according to the second embodiment.

In the second embodiment, the target supply unit 26 may include an aerosol supply device 65 and a powder output unit 35. The powder output unit 35 may be fixed to the chamber 2. The powder output unit 35 may supply aerosol supplied from the aerosol supply device 65 as the target 27 to the plasma generation region 25 in the chamber 2,

In the second embodiment, the main pulse laser device 3b may include a plurality of master oscillators 41 to 46, an optical path adjuster 47, a plurality of amplifiers PA1 and PA2, and a relay optical system 48.

The main pulse laser device 3b may irradiate the plasma generation region 25 with a main pulse laser beam having a high repetition frequency of 600 kHz, for example. This may enable the EUV light generation system 11 to output EUV light of approximately 200 W that can be utilized in an exposure apparatus.

In other respects, the second embodiment may be substantially the same as the first embodiment.

6.2 Details of Laser Device

6.2.1 Master Oscillators

As will be described below, each of the master oscillators 41 to 46 may be a quantum-cascade laser of a single longitudinal mode. The plurality of amplifiers PA1 and PA2 may be arranged in series in the optical paths of the pulse laser beams outputted from the master oscillators 41 to 46. Each of the amplifiers PA1 and PA2 may, for example, include a laser chamber (not illustrated) containing a CO₂ gas as a laser medium, a pair of electrodes (not illustrated) disposed in the laser chamber, and a power source (not illustrated) that applies a voltage between the pair of electrodes. The EUV light generation controller 5 may control the master oscillators 41 to 46 and the amplifiers PA1 and PA2.

The respective master oscillators 41 to 46 may output pulse laser beams of different wavelengths from each other toward the optical path adjuster 47. The optical path adjuster 47 may combine the pulse laser beams outputted from the respective master oscillators 41 to 46 into the same optical path, and may output a combined pulse laser beam toward the amplifier PA1. The amplifier PA1 may amplify the combined pulse laser beam outputted from the optical path adjuster 47 and output a pulse laser beam toward the amplifier PA2. The amplifier PA2 may amplify the pulse laser beam outputted from the amplifier PA1 and output a pulse laser beam toward the relay optical system 48. The relay optical system 48 may output, toward the laser beam direction control unit 34a, the pulse laser beam outputted from the amplifier PA2.

6.2.2 Optical Path Adjuster

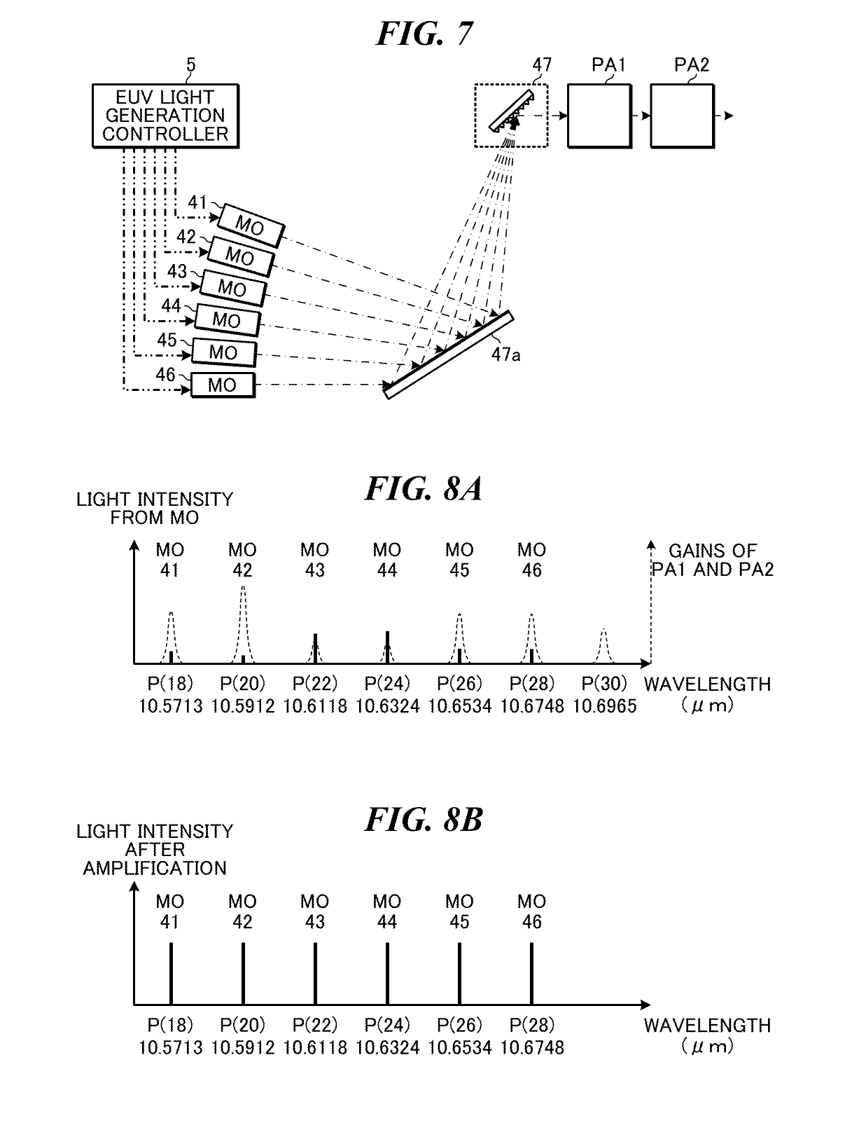

FIG. 7 specifically illustrates a configuration of the optical path adjuster 47 shown in FIG. 6. The optical path adjuster 47 may include a grating. The grating of the optical path adjuster 47 may be a wavelength dispersion element made of a high-reflectance material and having a large number of grooves. The direction of each of the grooves of the grating may be a direction substantially perpendicular to the paper surface of FIG. 7.

The master oscillators 41 to 46 may be different in their respective oscillation wavelengths from each other. The pulse laser beams outputted from the respective master oscillators 41 to 46 may be incident on the grating via a high-reflecting mirror 47a at predetermined angles according to the respective oscillation wavelengths. The master oscillators 41 to 46 may be disposed so that the respective pulse laser beams are diffracted by the grating at substantially the same angles of diffraction. As a result, the pulse laser beams from the respective master oscillators may be combined into substantially the same optical paths and enter the amplifier PA1.

6.2.3 Relationship Between Wavelengths of Pulse Laser Beams and Gains of Amplifiers

FIGS. 8A and 8B show relationship between the wavelengths of the pulse laser beams outputted from the respective master oscillators 41 to 46 shown in FIG. 6 and the gains of the amplifiers PA1 and PA2, and between wavelengths thereof and light intensities, respectively. In a case where the amplifiers PA1 and PA2 are CO₂ laser amplifiers, each of these amplifiers may have peak amplification factors in a P(18) line, a P(20) line, a P(22) line, a P(24) line, a P(26) line, a P(28) line, and a P(30) line.

In the present embodiment, the wavelengths of the pulse laser beams outputted by the respective master oscillators 41 to 46 may correspond to the wavelengths at which the peak amplification factors are achieved in the respective amplification lines of the CO₂ laser amplifiers. For example, the master oscillator 41 may be set to output a pulse laser beam at a wavelength of 10.5713 μm corresponding to the P(18) line. The master oscillator 42 may be set to output a pulse laser beam at a wavelength of 10.5912 μm corresponding to the P(20) line. The master oscillator 43 may be set to output a pulse laser beam at a wavelength of 10.6118 μm corresponding to the P(22) line. The master oscillator 44 may be set to output a pulse laser beam at a wavelength of 10.6324 μm corresponding to the P(24) line. The master oscillator 45 may be set to output a pulse laser beam at a wavelength of 10.6534 μm corresponding to the P(26) line. The master oscillator 46 may be set to output a pulse laser beam at a wavelength of 10.6748 μm corresponding to the P(28) line.

Further, the intensities of the pulse laser beams outputted by the respective master oscillators 41 to 46 may correspond to reciprocals of the peak values of the amplification factors in the respective amplification lines of each of the CO₂ laser amplifiers. For example, since the CO₂ laser amplifiers have the largest amplification factors in the P(20) line, the master oscillator 42 may output a weaker pulse laser beam than the other master oscillators 41 and 43 to 46. This may cause variations in light intensities of the respective pulse laser beams after amplification of the pulse laser beams to be smaller than variations in light intensities of the respective pulse laser beams outputted by the respective master oscillators 41 to 46. Furthermore, the energy of the pulse laser beam with which the target is irradiated may be adjusted by adjusting excitation intensities in the amplifiers PA1 and PA2. Therefore, the excitation intensities in the amplifiers PA1 and PA2 may be adjusted so that the energy of the pulse laser beam outputted from the main pulse laser device falls within a target range.

6.2.4 Moderating Gain Reduction

It may be necessary to increase the repetition frequency in order to improve energy of the EUV light in a case where the optimum range of the energy of the pulse laser beam is defined as described above to achieve the high conversion efficiency from the energy of the pulse laser beam into the energy of the EUV light.

For example, assuming that the energy of one pulse of the pulse laser beam is 25 mJ and the repetition frequency is 100 kHz, the output of the laser device may be 2.5 kW. Assuming that a conversion efficiency of 7% is obtained from this pulse laser beam, the output of the EUV light is 175 W. Making a correction to this output with typical collecting efficiency causes the output of the EUV light at the intermediate focus region 292 to be approximately 38 W. In the case of an attempt to increase the output at the intermediate focus region 292 to 200 W, it may be necessary to make the repetition frequency of the pulse laser beam 500 kHz, which is five times higher than the aforementioned 100 kHz, and preferably 600 kHz, which is six times higher than the aforementioned 100 kHz.

Meanwhile, in a gas laser device such as a CO₂ laser amplifier, a certain period of time is required from a time of amplification of one pulse of the pulse laser beam to a time of completing recovery of laser gain for amplifying the next pulse. This period of time is, for example, approximately several microseconds, although it may vary depending on gas conditions and excitation conditions of the amplifier. Assuming that the repetition frequency is 600 kHz, time intervals of the pulses become as short as 1.7 μs. Therefore, after one pulse has been amplified, the laser gain may not have recovered by the time when the next pulse is inputted. This may cause the amplification rate to become lower,

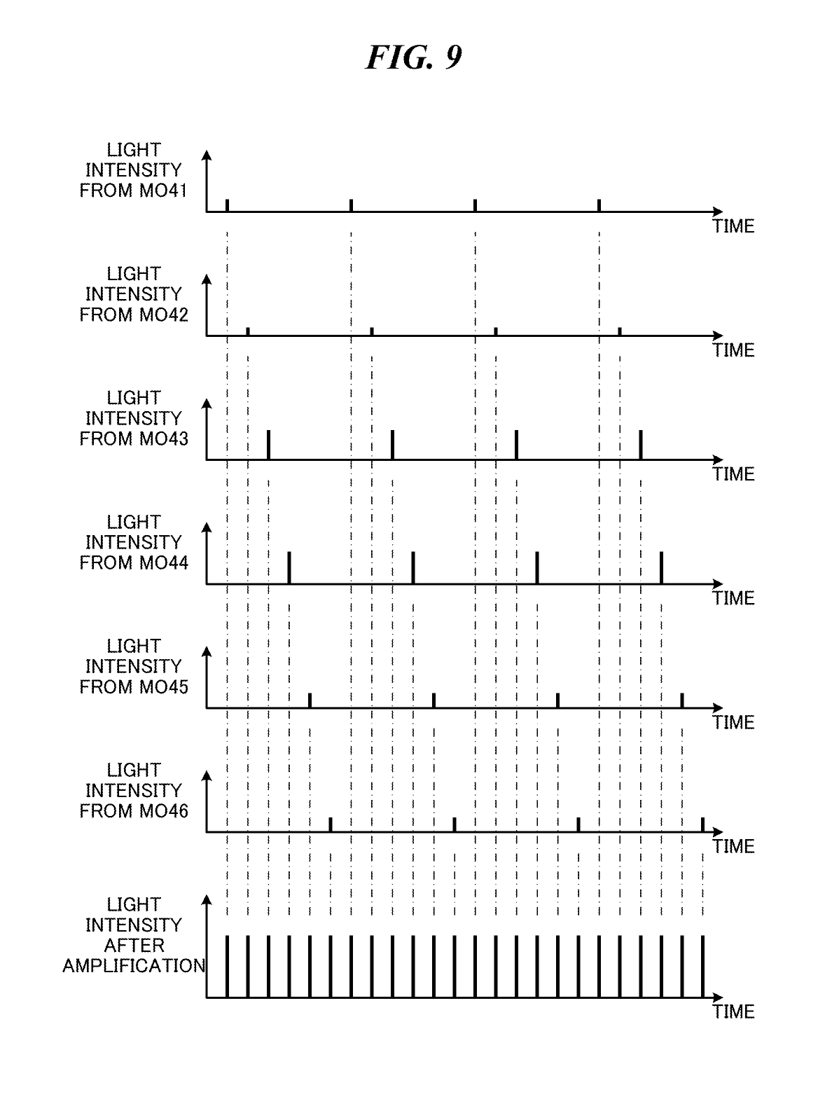

FIG. 9 is a timing chart of outputting the pulse laser beams in the main pulse laser device 3b shown in FIG. 6. Each of the master oscillators 41 to 46 may output a pulse laser beam, for example, at a repetition frequency of 100 kHz, i.e. at time intervals of 10 μs.

Output timings of the pulse laser beams outputted by the respective master oscillators 41 to 46 may be shifted at substantially equal intervals from each other. For example, the output timing of the pulse laser beam outputted by the master oscillator 42 may be shifted by approximately 1.7 μs from the output timing of the pulse laser beam outputted by the master oscillator 41. Similarly, the output timings of the pulse laser beams outputted by the respective master oscillators 43, 44, 45, and 46 may be shifted in sequence by approximately 1.7 μs. With this, the repetition frequency of the pulse laser beam obtained by combining the optical paths by the optical path adjuster 47 may be approximately 600 kHz.

In the amplifiers PA1 and PA2, amplification of the P(18) line leads to a reduction in laser gain of the P(18) line, but may moderate a reduction in laser gain for the other amplification lines. According to the aforementioned configuration, after the amplification of the P(18) line, the other amplification lines may be amplified without waiting for recovery of the laser gain of the P(18) line. The laser gain of the P(18) line may be recovered by the time the P(18) line is amplified next.

6.2.5 Example of Master Oscillator (Quantum-Cascade Laser)

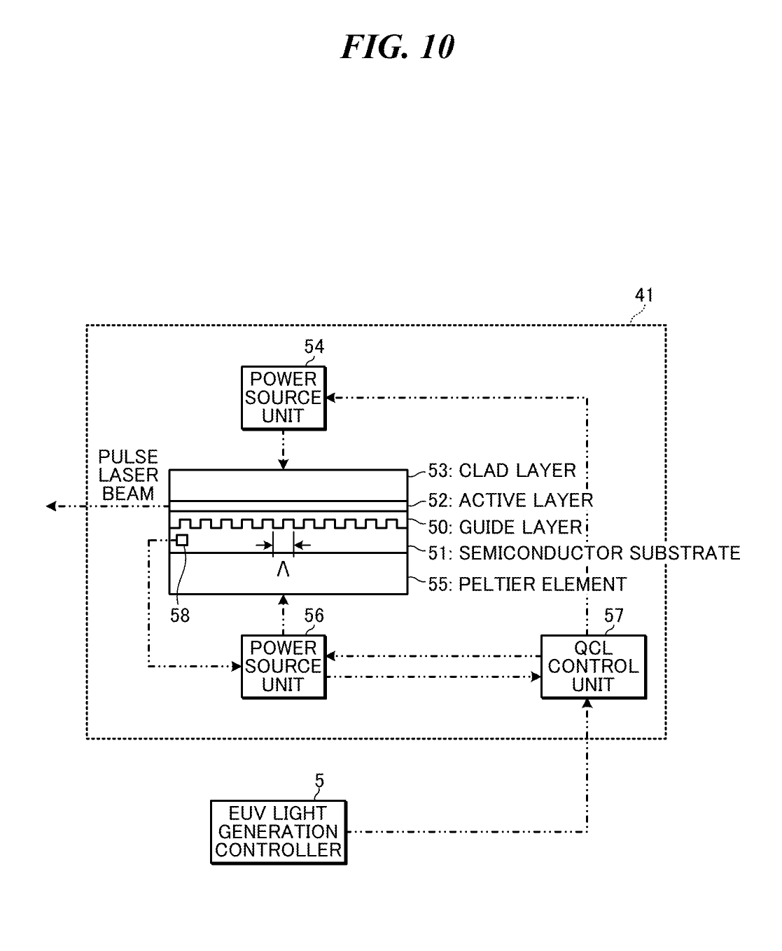

FIG. 10 schematically illustrates a configuration of the master oscillator 41 shown in FIG. 6. The master oscillator 41 may be a quantum-cascade laser of a single longitudinal mode and include a semiconductor substrate 51, a guide layer 50, an active layer 52, and a clad layer 53. The quantum-cascade laser may be a semiconductor laser using an inter-sub-band transition. A sub-band may be an electron state formed by confinement of quanta by quantum wells or the like. The active layer 52 has a configuration in which multiple quantum wells are connected, and may emit light more than once with one electron. A boundary surface between the semiconductor substrate 51 and the guide layer 50 may constitute a grating having a predetermined groove pitch A.

A power source unit 54 may be connected to the clad layer 53, and a pulse current may be supplied from the power source unit 54 to the active layer 52 via the clad layer 53. At this time, light generated in the active layer 52 may include a pulse laser beam of a single longitudinal mode wavelength selected by the grating, and the pulse laser beam may be amplified in the active layer 52 and outputted from the active layer 52. The pulse width of this outputted pulse laser beam may be adjustable according to pulse width of the pulse current supplied to the active layer 52. Therefore, the pulse width of the pulse current supplied to the active layer 52 may be adjusted so that the pulse width of the pulse laser beam outputted from the main pulse laser device falls within a target range.

A Peltier element 55 may be connected to the semiconductor substrate 51. The Peltier element 55 may be a semiconductor element in which heat is transferred from one surface to another by supplying electric current from a power source unit 56. The oscillation wavelength of the master oscillator 41 may be adjustable by adjusting the temperatures of the guide layer 50 and the active layer 52 by controlling, on the basis of an output from a temperature sensor 58 attached to the semiconductor substrate 51, the electric current supplied to the Peltier element 55. The power source units 54 and 56 may be controlled by a QCL control unit 57. The QCL control unit 57 may be controlled by the EUV light generation controller 5.

The master oscillators 42 to 46 may be substantially the same as the master oscillator 41.

6.3 Target Supply Unit that Supplies Powder Target

6.3.1 Aerosol Generator

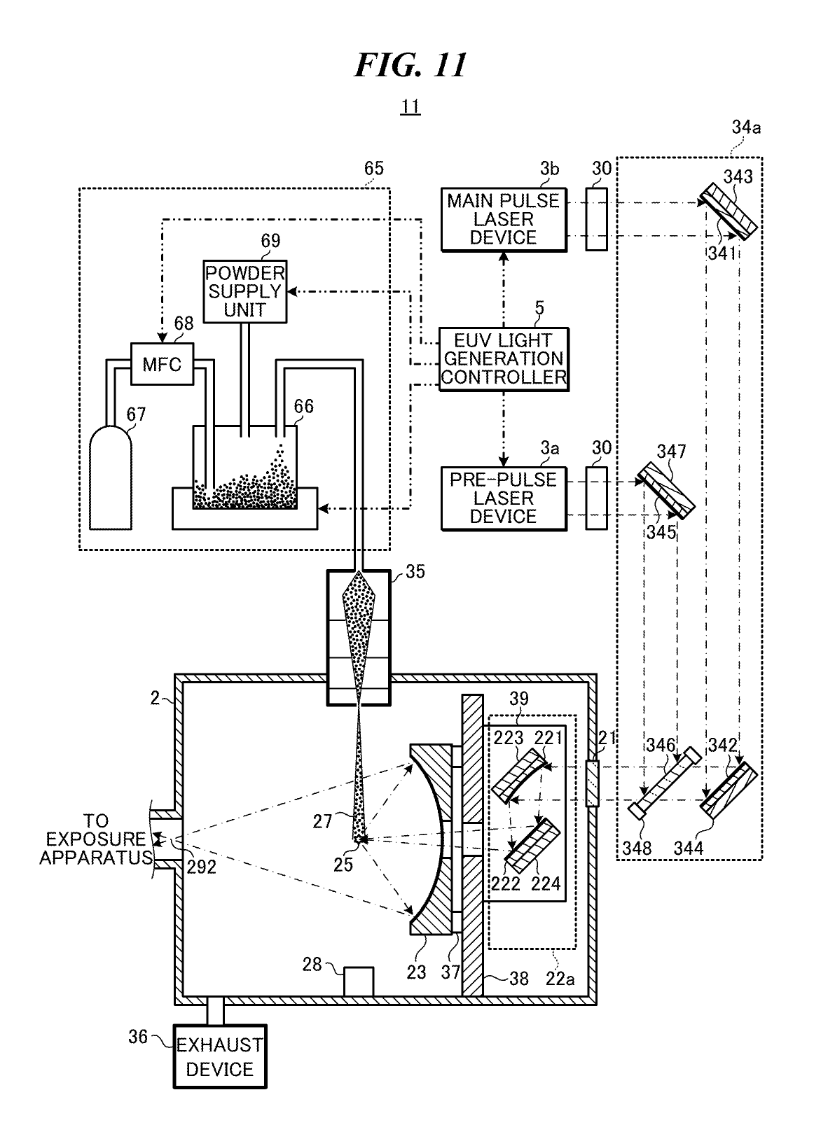

FIG. 11 illustrates a configuration of the aerosol supply device 65 shown in FIG. 6, together with the other components of the EUV light generation system 11. The aerosol supply device 65 may include a high-pressure gas cylinder 67, a mass flow controller 68, a powder supply unit 69, and an aerosol generator 65.

The high-pressure gas cylinder 67 may contain a carrier gas such as a helium gas (He), an argon gas (Ar), a hydrogen gas (H₂), a mixture of the helium gas and the hydrogen gas, or a mixture of the argon gas and the hydrogen gas. The high-pressure gas cylinder 67 may be connected to the aerosol generator 66 through a gas pipe. The gas pipe between the high-pressure gas cylinder 67 and the aerosol generator 66 may be provided with the mass flow controller 68. The mass flow controller 68 may control, in accordance with a control signal from the EUV light generation controller 5, the flow rate of the carrier gas supplied from the high-pressure gas cylinder 67 to the aerosol generator 66.

The powder supply unit 69 may be a mechanism that forms the target material into powder, and supplies the powder into a container of the aerosol generator 66. The powder supply unit 69 may generate the powder, for example, by a sputtering method, a laser ablation method, or the like. The amount and the particle diameter of the powder generated by the powder supply unit 69 may be controlled in accordance with a control signal from the EUV light generation controller 5. The aerosol generator 66 may have a vibration mechanism (not illustrated), and this vibration mechanism may be operated in accordance with a control signal from the EUV light generation controller 5. The aerosol generator 66 may generate the aerosol by dispersing, in the carrier gas supplied from the high-pressure gas cylinder 67, the powder containing the target material generated by the powder supply unit 69.

The powder output unit 35 may output, toward the plasma generation region 25 in the chamber 2, powder target 27 contained in the aerosol generated by the aerosol generator 66. Force with which the aerosol is supplied from the aerosol generator 66 into the chamber 2 may be given by a differential pressure between the pressure inside the chamber 2 as adjusted by the exhaust device 36 and the pressure of the carrier gas supplied from the high-pressure gas cylinder 67. The powder target 27 may be outputted in a beam form. The atomic density of the target material in the plasma generation region 25 may be 8.0×10¹⁷ atoms/cm³ or higher and 1.3×10¹⁸ atoms/cm³ or lower. Alternatively, irradiation of the powder target 27 with the pre-pulse laser beam outputted from the pre-pulse laser device 3a may cause the target material in the plasma generation region 25 to be further dispersed, so that the atomic density of the target material may become 8.0×10¹⁷ atoms/cm³ or higher and 1.3×10¹⁸ atoms/cm³ or lower. Irradiation of the target material of such an atomic density with the main pulse laser beam may cause the target material to be turned into plasma and to generate the EUV light.

Preferably, the energy density of the main pulse laser beam may be 10.5 J/cm² or higher and 52.3 J/cm² or lower. The pulse width of the main pulse laser beam may be 1.0 ns or more and 3.7 ns or less.

More preferably, the energy density of the main pulse laser beam may be 26.2 J/cm² or higher and 40.0 J/cm² or lower. The pulse width of the main pulse laser beam may be 2.0 ns or more and 2.6 ns or less.

The target material, diffused along with generation of plasma, may adhere to the reflective surface of the EUV collector mirror 23 and may reduce reflectance of the EUV light by the EUV collector mirror 23. Therefore, in the case where the target material contains tin (Sn), it is preferable that the carrier gas contains hydrogen gas, indicated in Formula 1 below, the hydrogen gas can become hydrogen radical (H*) upon being irradiated with the EUV light. As indicated in Formula 2 below, this hydrogen radical and tin having adhered to the EUV collector mirror 23 may react with each other to generate stannane (SnH₄), which takes the form of a gas at normal temperature.

H₂→2H* Formula 1

Sn+4H*→SnH₄ Formula 2

This may cause the target material having adhered to the EUV collector mirror 23 to be etched so that the life of the EUV collector mirror 23 may be lengthened.

6.3.2 Configuration of Aerodynamic Lens

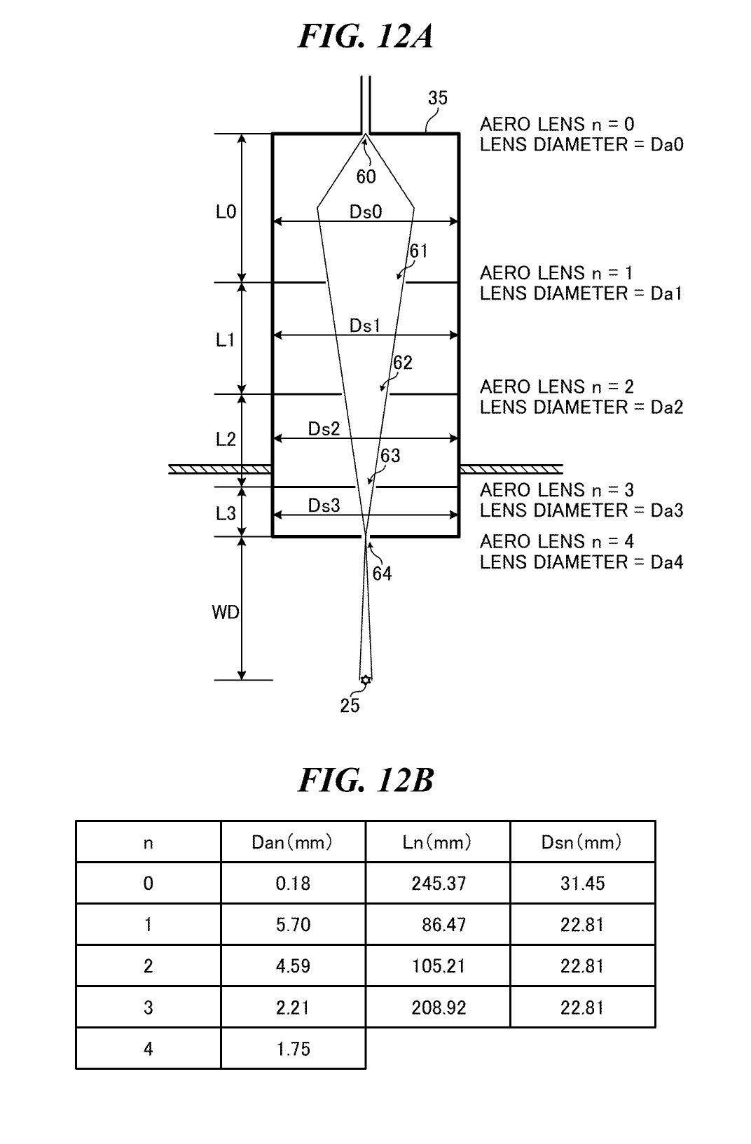

FIG. 12A schematically illustrates an exemplary configuration of the powder output unit 35 shown in FIG. 6. The powder output unit 35 of the target supply unit 26 may include an aerodynamic lens. The aerodynamic lens may be configured to have several orifice plates therein which are arranged in a row. The aerodynamic lens may introduce the aerosol generated by the aerosol generator 66 (see FIG. 11) on a high-pressure side into the chamber 2 on a low-pressure side. The aerodynamic lens may form the powder contained in the aerosol to a beam-shape and output the powder to the plasma generation region 25 in the chamber 2.

Use of the aerodynamic lens may make it possible to cause much of the powder target 27 to reach the plasma generation region 25 by suppressing dispersion of the powder target 27 in the chamber 2, thus making it possible to improve efficiency of using the powder target 27. Further, the use of the aerodynamic lens may make distance (WD) between the powder output unit 35 and the plasma generation region 25 sufficiently long.

6.3.3 Exemplary Design of Aerodynamic Lens

FIG. 12B shows dimensions of components of a designed aerodynamic lens.

As shown in FIG. 12A, the aerodynamic lens which constitutes the powder output unit 35 may include a tube having an opening 60 formed at one end thereof and an orifice formed at the other end thereof. The opening 60 may communicate with the aerosol generator 66, and the orifice may communicate with the chamber 2. The orifice, which communicates with the chamber 2, may be a fourth orifice 64. Between the opening 60 and the fourth orifice 64, in the tube which constitutes the aerodynamic lens, a first orifice 61, a second orifice 62, and a third orifice 63 in this order from the side of the opening 60 may be formed.

Here, suppose Da0 is a diameter of the opening 60 (n=0), Da1 is a diameter of the first orifice 61 (n=1), Da2 is a diameter of the second orifice 62 (n=2), Da3 is a diameter of the third orifice 63 (n=3), and Da4 is a diameter of the fourth orifice 64 (n=4). A position of the opening 60 may be set to n=0, a position of the first orifice 61 may be set to n=1, a position of the second orifice 62 may be set to n=2, a position of the third orifice 63 may be set to n=3, and a position of the fourth orifice 64 may be set to n=4.

Further, suppose L0 is a distance between the opening 60 and the first orifice 61, L1 is a distance between the first orifice 61 and the second orifice 62, L2 is a distance between the second orifice 62 and the third orifice 63, and L3 is a distance between the third orifice 63 and the fourth orifice 64.

Further, suppose Ds0 is an inner diameter of the tube between the opening 60 and the first orifice 61, Ds1 is an inner diameter of the tube between the first orifice 61 and the second orifice 62, Ds2 is an inner diameter of the tube between the second orifice 62 and the third orifice 63, and Ds3 is an inner diameter of the tube between the third orifice 63 and the fourth orifice 64.

As one example, suppose that the carrier gas may include helium gas and that the powder contained in the aerosol may include solid fine particles of tin each of which has a diameter Dp of 10 nm. Further, suppose that the distance WD from the fourth orifice 64 to the plasma generation region 25 is 100 mm. Further, suppose that the input pressure Pin to the aerodynamic lens is 101325 Pa and the pressure Pout inside the chamber 2 is 0.1 Pa.

FIG. 12B shows results obtained by designing the aerodynamic lens so that the beam diameter of the powder target 27 at the plasma generation region 25 is in a range of 280 μm to 400 μm and so that the velocity V of the powder target 27 is 370 m/s.

Such a powder target 27 may be irradiated with a pulse laser beam, for example, of 300 μm in focus spot diameter at a repetition frequency of 500 kHz to 600 kHz. This may make it possible to generate the EUV light at the repetition frequency of 500 kHz to 600 kHz. The focus spot diameter may be a diameter of a portion having an intensity of 1/e² or higher of the peak intensity in an intensity distribution of the focus spot.

Further, the cycle period of the pulse laser beam at a repetition frequency of 500 kHz is 2 μs. Therefore, if the velocity V of the powder target 27 is 370 m/s, the powder target 27 may be irradiated with one pulse of the pulse laser beam at every time the powder target 27 travels 740 μm. This may prevent plasma generated by one pulse of the pulse laser beam from exerting a great influence on the trajectory of the target to be irradiated with the next pulse. From this point of view, it is preferable that the velocity V of the powder target 27 is 360 m/s or higher. Furthermore, it is preferable that the velocity V of the powder target 27 is 500 m/s or higher.

6.4 Corrective Optical Element

With continued reference to FIG. 11, corrective optical elements 30 may be provided in the respective optical paths of the pulse laser beam outputted from the pre-pulse laser device 3a and the pulse laser beam outputted from the main pulse laser device 3b. Each of the corrective optical elements 30 may be an optical element that converts a light intensity distribution of a pulse laser beam from a Gaussian distribution into a semi-top-hat distribution. The semi-top-hat distribution may mean that the light intensity of the pulse laser beam includes a region having a substantially uniform light intensity distribution.

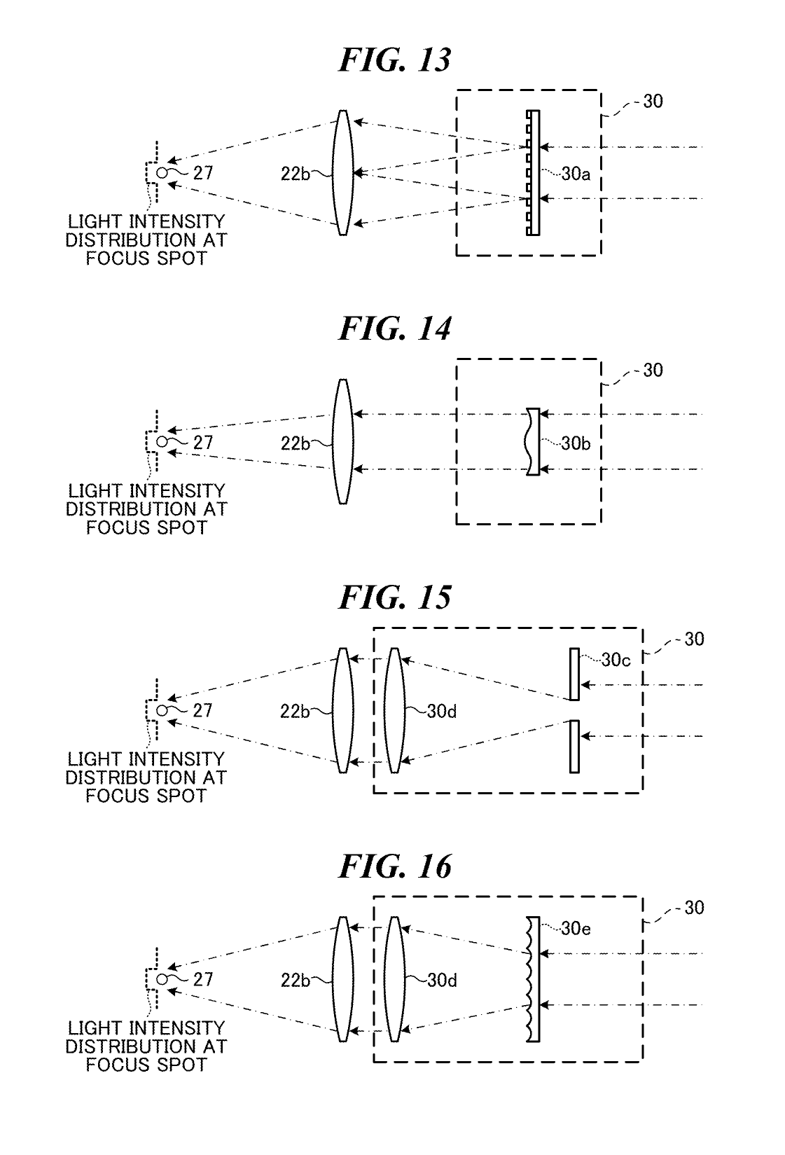

FIG. 13 is a conceptual diagram illustrating an example of the corrective optical element 30. The corrective optical element 30 shown in FIG. 13 may include a diffractive optical element 30a. The diffractive optical element 30a may include a transparent plate having minute depressions and/or protrusions formed to diffract an incident beam. A pattern of the depressions and/or protrusions of the diffractive optical element 30a may be designed so as to uniform the light intensity distribution at the focus spot in a case where diffracted light is focused by a laser beam focusing optical system 22b. This may allow the powder target 27 to be irradiated with the pre-pulse laser beam or the main pulse laser beam whose light intensity distribution is the semi-top-hat distribution.

FIG. 14 is a conceptual diagram illustrating another example of the corrective optical element 30. The corrective optical element 30 shown in FIG. 14 may include a phase-shift optical system 30b. The phase-shift optical system 30b may include, for example, a transparent plate that is thicker in a central part than in a peripheral part. The phase-shift optical system 30b may give a phase difference n between rays of light transmitted through the central part and rays of light transmitted through the peripheral part. This may allow an incident beam whose light intensity distribution is a Gaussian distribution to be converted into light having an electric field intensity distribution approximate to an Airy function and outputted from the phase-shift optical system 30b.

Moreover, for example, the laser beam focusing optical system 22b may be disposed so that the position of the rear focal point of the laser beam focusing optical system 22b coincides with a point on the path of the target 27, and the phase-shift optical system 30b may be disposed in the position of the front focal point of the laser beam focusing optical system 22b. This may allow the powder target 27 to be irradiated with the pre-pulse laser beam or the main pulse laser beam whose light intensity distribution is the semi-top-hat distribution obtained by performing a Fourier transform on the Airy function. In the example described here, the phase-shift optical system 30b used is of a transmissive type. Without being limited to this, the phase-shift optical system may be of a reflective type.

FIG. 15 is a conceptual diagram illustrating still another example of the corrective optical element 30. The corrective optical element 30 shown in FIG. 15 may include a mask 30c having an opening of a predetermined shape. The mask 30c, a collimator lens 30d, and the laser beam focusing optical system 22b may constitute a reduced projection optical system. The mask 30c may transmit only rays of light in a region where the light intensity distribution of the incoming pulse laser beam has a predetermined uniformity. The reduced projection optical system may form an image by projecting an image of the opening of the mask 30c onto the target 27 in a reduced form though the collimator lens 30d and the laser beam focusing optical system 22b. This may allow the powder target 27 to be irradiated with the pre-pulse laser beam or the main pulse laser beam whose light intensity distribution is the semi-top-hat distribution.

FIG. 16 is a conceptual diagram illustrating still another example of the corrective optical element 30. The corrective optical element 30 shown in FIG. 16 may include a fly-eye lens 30e having a large number of concave lenses arrayed. The fly-eye lens 30e, the collimator lens 30d, and the laser beam focusing optical system 22b may constitute a Köhler illumination optical system. In the Köhler illumination optical system, an incident beam is diffused into beams of light at predetermined angles by the respective concave lenses of the fly-eye lens 30e. The beams of light may be combined by being focused by the collimator lens 30d and the laser beam focusing optical system 22b. As a result, the light intensity distribution of the pulse laser beam can be made substantially uniform. This may allow the powder target 27 to be irradiated with the pre-pulse laser beam or the main pulse laser beam whose light intensity distribution is the semi-top-hat distribution. In the example described here, the fly-eye lens 30e used is of a transmissive type. Without being limited to this, the fly-eye lens 30e may be of a reflective type. Alternatively, the fly-eye lens 30e may be a fly-eye lens having an array of a large number of convex lenses, or may be a micro fly-eye lens constituted by micro-lenses.

### 7. Modification of Laser Device (Third Embodiment)

7.1 Master Oscillator

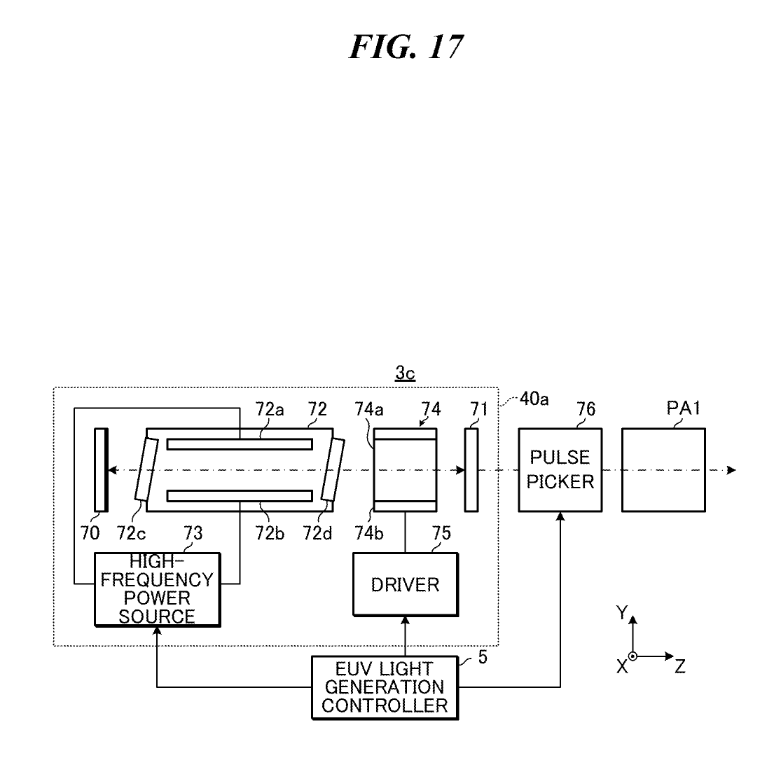

FIG. 17 schematically illustrates a configuration of a main pulse laser device 3c used in an EUV light generation system according to a third embodiment. In the third embodiment, the main pulse laser device 3c may include a master oscillator 40a including an actively mode-locked laser device, a pulse picker 76, and an amplifier PA1. Although not illustrated in FIG. 17, the main pulse laser device 3c may include a plurality of amplifiers.

The master oscillator 40a may include an optical resonator constituted by a high-reflecting mirror 70 and a partial-reflecting mirror 71. Between the high-reflecting mirror 70 and the partial-reflecting mirror 71, a CO₂ laser discharge tube 72 and an acousto-optical element 74 may be disposed in this order from the side of the high-reflecting mirror 70.

The CO₂ laser discharge tube 72 may have a pair of electrodes 72a and 72b disposed therein. The CO₂ laser discharge tube 72 may seal a laser medium containing a CO₂ gas. The CO₂ laser discharge tube 72 may have a pair of windows 72c and 72d attached thereto. The pair of windows 72c and 72d may be disposed so that the angle of incidence of a laser beam passing through the window 72c to the window 72d is a Brewster's angle. The individual electrodes 72a and 72b may be electrically connected to a high-frequency power source 73 disposed outside of the CO₂ laser discharge tube 72. The high-frequency power source 73 may supply a high-frequency voltage that causes discharge to occur between the pair of electrodes 72a and 72b, and this discharge may excite the laser medium to generate light.

The light generated in the CO₂ laser discharge tube 72 may include a plurality of longitudinal modes (frequency components). The high-reflecting mirror 70 may reflect, at high reflectance, the light emitted from the CO₂ laser discharge tube 72 to return the light to the CO₂ laser discharge tube 72. The light returned to the CO₂ laser discharge tube 72 may be amplified in the CO₂ laser discharge tube 72 and emitted from the CO₂ laser discharge tube 72.

The partial-reflecting mirror 71 may cause a part of the light generated and amplified in the CO₂ laser discharge tube 72 to be transmitted toward the outside of the optical resonator and reflect another part toward the CO₂ laser discharge tube 72 so that the reflected part is further amplified in the CO₂ laser discharge tube 72.

The acousto-optical element 74 may include an acousto-optical medium 74a and a piezoelectric element 74b. The piezoelectric element 74b may be supplied with a high-frequency voltage from a driver 75. Supplying the high-frequency voltage to the piezoelectric element 74b may cause the piezoelectric element 74b to generate ultrasonic waves that may be transmitted as compression waves into the acousto-optical medium 74a. These compression waves may change the index of refraction of light in the acousto-optical medium 74a. The frequency of the ultrasonic waves transmitted from the piezoelectric element 74b into the acousto-optical medium 74a may be, for example, 150 MHz. Changes in the index of refraction of light in the acousto-optical medium 74a may cause a laser beam that reciprocates within the optical resonator to be cut out.

Cutting out the laser beam by the acous to-optical element 74 may cause the laser beam that reciprocates within the optical resonator to become a pulse laser beam. The pulse laser beam may further be amplified when it passes through the CO₂ laser discharge tube 72, and may become a more intense pulse laser beam every time it reciprocates within the optical resonator. Assuming that, for example, the resonator length L of the optical resonator is 1 in and the speed of light c is 3×10⁸ m/s, the repetition frequency f of the pulse laser beam is obtained by the formula below. That is, the pulse laser beam may reciprocate 1.5×10⁸ times a second within the optical resonator.

$$\begin{matrix}f = c / 2 L \\ = 3 \times {10}^{8} / 2\end{matrix}$$

With this configuration, by matching the time required for the pulse laser beam to reciprocate once within the optical resonator and the cycle of changes in the index of refraction in the acousto-optical medium 74a, a pulse laser beam having a desired high repetition frequency may be outputted from the optical resonator.

The pulse width of the pulse laser beam outputted from the master oscillator 40a may be varied by changing the pressure of the CO₂ laser gas in the CO₂ laser discharge tube 72. A reason for this is as follows. According to the pressure of the CO₂ laser gas, bandwidth of amplification wavelength may change. Changing the bandwidth of the amplification wavelength may cause the pulse width of the mode-locked pulse laser beam to be changed. Therefore, the pressure of the CO₂ laser gas in the master oscillator may be controlled so that the pulse width of the pulse laser beam outputted from the main pulse laser device falls within a target range.

7.2 Pulse Picker

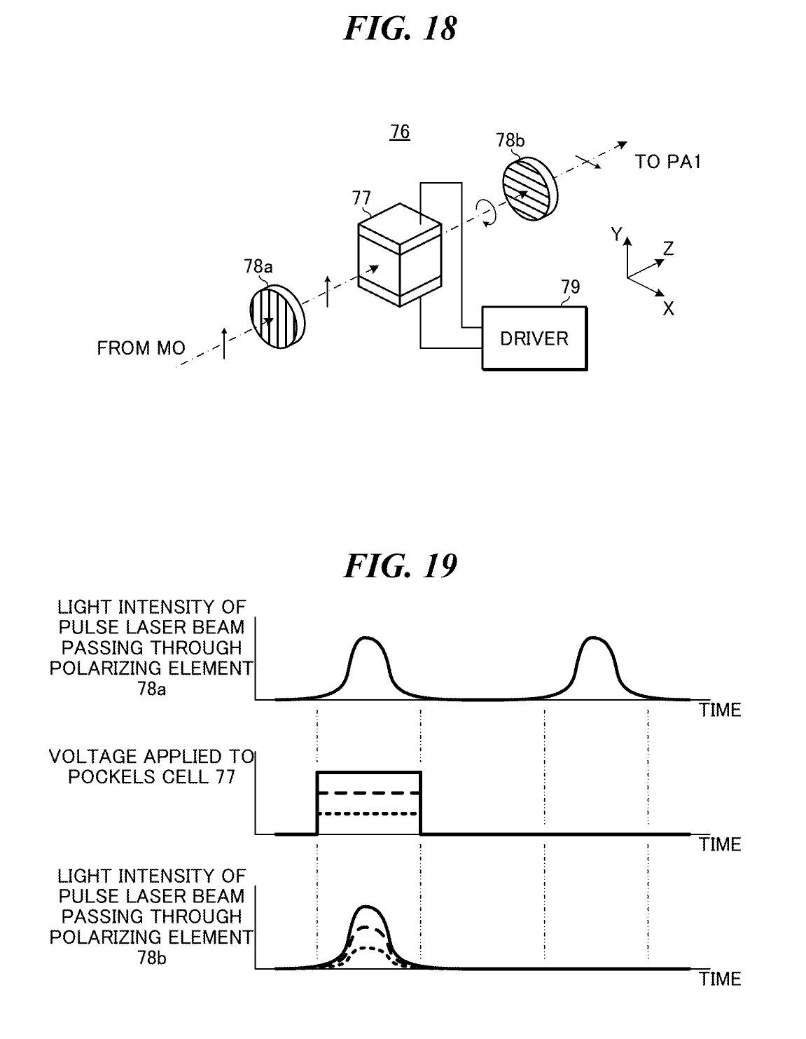

FIG. 18 schematically illustrates a first exemplary configuration of the pulse picker 76 shown in FIG. 17. The pulse picker 76 may include a Pockels cell 77, a pair of polarizing elements 78a and 78b, and a driver 79. The Pockels cell 77 may be disposed in the optical path of a pulse laser beam outputted from the master oscillator 40a. The Pockels cell 77 may be able to, when a voltage is applied by the driver 79, change a polarization state of a pulse laser beam passing through the Pockels cell 77. The pair of polarizing elements 78a and 78b may be disposed in the optical path of the pulse laser beam with the Pockels cell 77 interposed therebetween. The pair of polarizing elements 78a and 78b may be disposed so that planes of polarization of pulse laser beams selected by the respective polarizing elements 78a and 78b are orthogonal to each other.

The pulse laser beam outputted from the master oscillator 40a may be a linearly polarized beam having a plane of polarization that is parallel to the Y direction, since the pair of windows 72c and 72d are disposed at the Brewster's angle as shown in FIG. 17. This pulse laser beam may pass through the polarizing element 78a.

When a voltage is not applied from the driver 79 to the Pockels cell 77, the Pockels cell 77 may allow passage of the pulse laser beam without changing the polarization state of the pulse laser beam. This pulse laser beam may be reflected or absorbed without passing through the polarizing element 78b.

When a voltage is applied from the driver 79 to the Pockels cell 77, the Pockels cell 77 may change the polarization state of the pulse laser beam from the linearly polarized beam having a plane of polarization that is parallel to the Y direction into an elliptically polarized beam or linearly polarized beam having a plane of polarization that is parallel to the X direction. At least a part of this pulse laser beam may pass through the polarizing element 78b and enter the amplifier PA1 as the linearly polarized beam having a plane of polarization that is parallel to the X direction.

FIG. 19 shows a relationship between the voltage applied to the Pockels cell 77 and the pulse laser beam.

The pulse laser beam outputted from the master oscillator 40a may pass through the polarizing element 78a, but selective passage may be achieved by controlling the voltage applied to the Pockels cell 77. The frequency and phase of the voltage applied to the Pockels cell 77 may be determined according to the frequency and phase of the ultrasonic waves transmitted to the inside of the acousto-optical medium 74a in the acousto-optical element 74 (see FIG. 17). In a case where the frequency of the ultrasonic waves is 150 MHz, for example, the frequency of the voltage applied to the Pockels cell 77 may be 600 kHz. That is, the pulse picker 76 may allow passage of one pulse of the pulse laser beam at every 250 pulses of the pulse laser beam from the master oscillator 40a.

Further, the light intensity of the pulse laser beam passing through the polarizing element 78b may be controlled by controlling the magnitude of the voltage applied to the Pockels cell 77. As indicated by a solid line in FIG. 19, the light intensity of the pulse laser beam passing through the polarizing element 78b may become higher in a case where the voltage applied to the Pockels cell 77 is high. As indicated by two types of broken lines in FIG. 19, the light intensity of the pulse laser beam passing through the polarizing element 78b may become lower as the voltage applied to the Pockels cell 77 becomes smaller.

7.3 Regenerative Amplifier

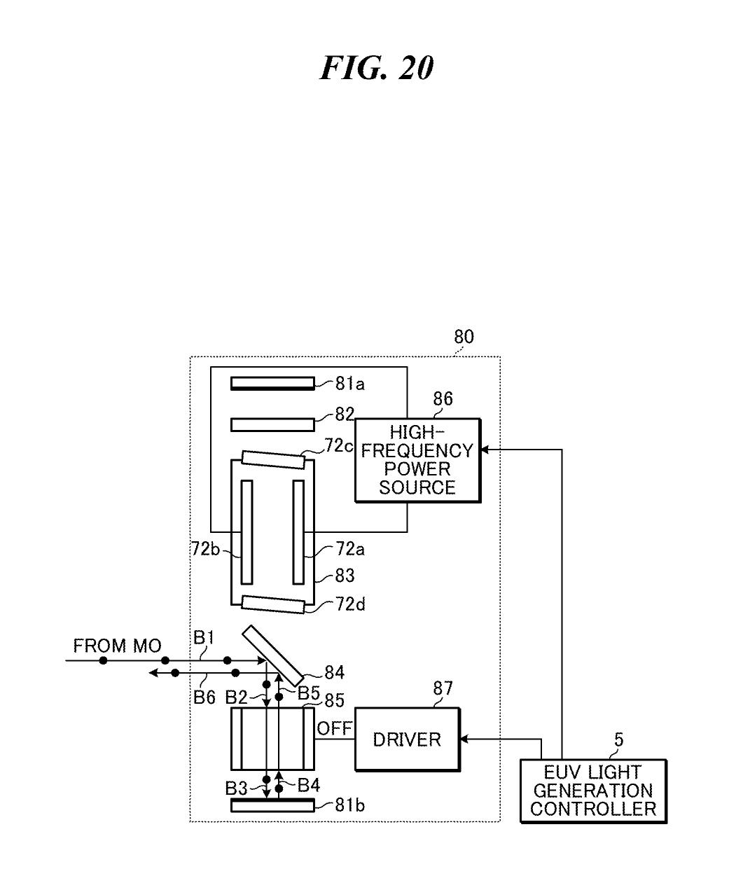

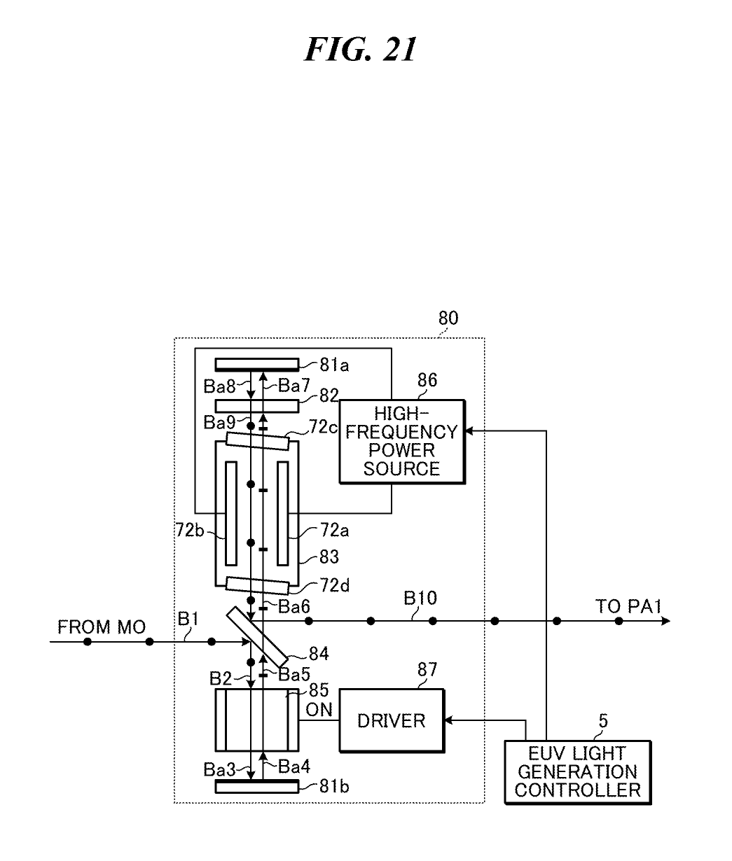

FIGS. 20 and 21 schematically illustrate a second exemplary configuration of the pulse picker 76 shown in FIG. 17. In the second exemplary configuration, the pulse picker 76 may include a regenerative amplifier 80. That is, the pulse picker 76 may not only remove some pulses of the pulse laser beam but also amplify some other pulses of the pulse laser beam.

As shown in FIGS. 20 and 21, the regenerative amplifier 80 may include an optical resonator constituted by a pair of high-reflecting mirrors 81a and 81b. Between the pair of high-reflecting mirrors 81a and 81b, a quarter wavelength plate 82, a CO₂ laser discharge tube 83, a polarization beam splitter 84, and a Pockets cell 85 may be disposed in this order from the side of the high-reflecting mirror 81a.

Configurations of the CO₂ laser discharge tube 83 and the inside thereof may be substantially the same as those of the CO₂ laser discharge tube 72 shown in FIG. 17. Individual electrodes 72a and 72b in the CO₂ laser discharge tube 83 may be electrically connected to a high-frequency power source 86 disposed outside of the CO₂ laser discharge tube 83. The high-frequency power source 86 may supply a high-frequency voltage that causes discharge to occur between the pair of electrodes 72a and 72b, and this discharge may excite the laser medium inside of the CO₂ laser discharge tube 83. A beam having entered the CO₂ laser discharge tube 83 may be amplified in the CO₂ laser discharge tube 83 and emitted from the CO₂ laser discharge tube 83.

The Pockels cell 85 may be able to, when a voltage is applied by a driver 87, change a polarization state of the pulse laser beam passing through the Pockels cell 85. The change in the polarization state by the Pockels cell 85 may be a change from a linearly polarized beam to a circularly polarized beam, or a change from a circularly polarized beam to a linearly polarized beam. When a linearly polarized beam becomes a circularly polarized beam by passing through the Pockels cell 85 and then passes through the Pockels cell 85 again, the pulse laser beam may become a linearly polarized beam whose plane of polarization has rotated 90 degrees with respect to the initial linearly polarized beam,

FIG. 20 illustrates optical paths of pulse laser beams in a case where a voltage is not applied to the Pockels cell 85 by the driver 87.

A pulse laser beam 31 outputted from the master oscillator 40a may be a linearly polarized beam having a plane of polarization that is perpendicular to the paper surface. The pulse laser beam 31 may be reflected by the polarization beam splitter 84 and enter the Pockels cell 85 as a pulse laser beam 32. In the case where a voltage is not applied to the Pockels cell 85 by the driver 87, the pulse laser beam 32 may pass through the Pockels cell 85 while maintaining the orientation of the plane of polarization and enter the high-reflecting mirror 81b as a pulse laser beam B3.

The pulse laser beam 33 may be reflected by the high-reflecting mirror 81b and enter the Pockels cell 85 as a pulse laser beam B4. The pulse laser beam B4 may pass through the Pockels cell 85 while maintaining the orientation of the plane of polarization and enter the polarization beam splitter 84 as a pulse laser beam B5. The pulse laser beam 35 may be reflected by the polarization beam splitter 84 and outputted as a pulse laser beam 36 from the regenerative amplifier 80 without once being amplified.

FIG. 21 illustrates optical paths of pulse laser beams in a case where the voltage is applied to the Pockels cell 85 by the driver 87.

The pulse laser beam 31 outputted from the master oscillator 40a may be a linearly polarized beam having the plane of polarization that is perpendicular to the paper surface. The pulse laser beam B1 may be reflected by the polarization beam splitter 84 and enter the Pockels cell 85 as the pulse laser beam B2. In the case where the voltage is applied to the Pockels cell 85 by the driver 87, the pulse laser beam 32 may change into a circularly polarized beam by passing through the Pockels cell 85, and enter the high-reflecting mirror 81b as a pulse laser beam Ba3.

The pulse laser beam Ba3 may be reflected by the high-reflecting mirror 81b and enter the Pockels cell 85 as a pulse laser beam Ba4. The pulse laser beam Ba4 may change into a linearly polarized beam having a plane of polarization that is parallel to the paper surface by passing through the Pockels cell 85 and enter the polarization beam splitter 84 as a pulse laser beam Ba5. The pulse laser beam Ba5 may pass through the polarization beam splitter 84, and enter the CO₂ laser discharge tube 83 as a pulse laser beam Ba6.

The pulse laser beam Ba6 may be amplified in the CO₂ laser discharge tube 83 and enter the quarter wavelength plate 82. The pulse laser beam Ba6 may change into a circularly polarized beam by passing through the quarter wavelength plate 82 and enter the high-reflecting mirror 81a as a pulse laser beam Ba7.

The pulse laser beam Ba7 may be reflected by the high-reflecting mirror 81a and enter the quarter wavelength plate 82 as a pulse laser beam Ba8. The pulse laser beam Ba8 may change into a linearly polarized beam having a plane of polarization that is perpendicular to the paper surface by passing through the quarter wavelength plate 82 and enter the CO₂ laser discharge tube 83 as a pulse laser beam Ba9.

The pulse laser beam Ba9 may be amplified in the CO₂ laser discharge tube 83 and enter the polarization beam splitter 84. The pulse laser beam Ba9 may be reflected by the polarization beam splitter 84 and outputted as a pulse laser beam B10 from the regenerative amplifier 80 toward the amplifier PA1.

As described above, a pulse laser beam may be amplified and outputted toward the amplifier PA1 only when a voltage is applied to the Pockels cell 85.

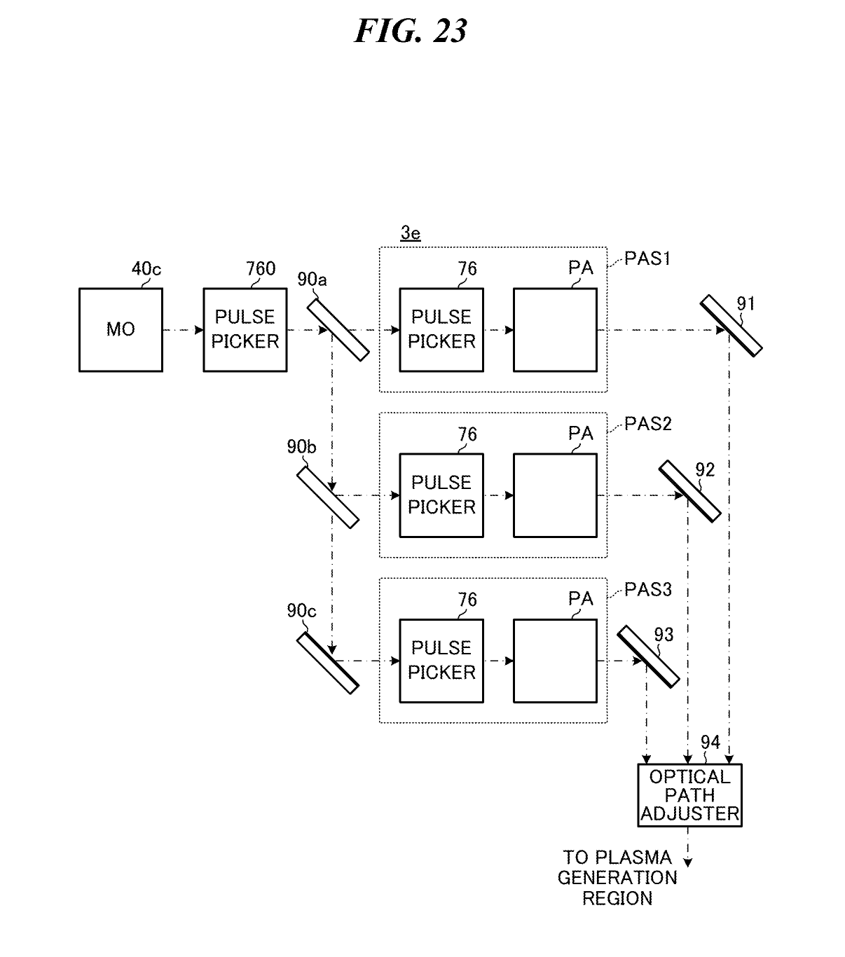

The present disclosure is not limited to the aforementioned configuration, and both the pulse picker 76 shown in FIG. 18 and the regenerative amplifier 80 shown in FIG. 20 may be disposed in the optical path of a pulse laser beam (see FIG. 23).

### 8. Modification of Laser Device (Fourth Embodiment)

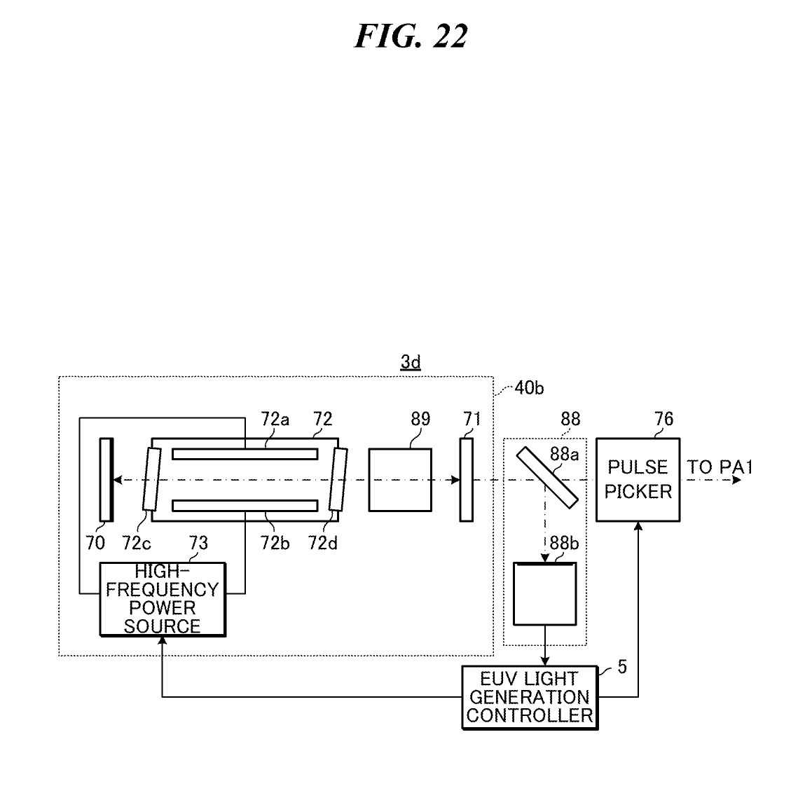

FIG. 22 schematically illustrates a configuration of a main pulse laser device 3d used in an EUV light generation system according to a fourth embodiment. In the fourth embodiment, the main pulse laser device 3d may include a master oscillator 40b including a passively mode-locked laser device, an optical sensor module 88, and a pulse picker 76. Although not illustrated in FIG. 22, the main pulse laser device 3d may further include at least one amplifier.

The master oscillator 40b may differ from the master oscillator 40a shown in FIG. 17 in that the master oscillator 40b includes a saturable absorber cell 89 instead of the acousto-optical element 74 and the driver 75. In other respects, the master oscillator 40b may be substantially the same as the master oscillator 40a shown in FIG. 17. The saturable absorber cell 89 may absorb most of an incident beam while the incident beam is weaker than a predetermined threshold. When the incident beam becomes equal to or stronger than the threshold, the saturable absorber cell 89 may transmit the incident beam at high transmittance. This may allow only a beam whose intensity is instantaneously high to pass through the saturable absorber cell 89 at the time when the phases of the plurality of longitudinal modes included in the light generated in the CO₂ laser discharge tube 72 match with each other.

Thus, a pulse laser beam in which the phases of the plurality of longitudinal modes of light are relatively fixed may be amplified by reciprocating within the optical resonator. The pulse laser beam thus amplified may be periodically outputted from the partial-reflecting mirror 71. The repetition frequency f of this pulse laser beam may depend on the resonator length L of the optical resonator and the speed of light c as indicated by the following formula:

f=c/2L

The optical sensor module 88 may include a beam splitter 88a and an optical sensor 88b. The beam splitter 88a may reflect a part of the pulse laser beam outputted from the master oscillator 40b and transmit another part toward the pulse picker 76 at high transmittance. The pulse laser beam reflected by the beam splitter 88a may be incident on a photosensitive surface of the optical sensor 88b. The optical sensor 88b may output, to the EUV light generation controller 5, a signal indicating a time of detection of the pulse laser beam. The EUV light generation controller 5 may control the pulse picker 76 in accordance with the signal received from the optical sensor 88b. For example, the pulse picker 76 may allow passage of one pulse of the pulse laser beam at every 250 pulses of the pulse laser beam outputted from the master oscillator 40b.

In other respects, the main pulse laser device 3d may be substantially the same as the main pulse laser device 3c shown in FIG. 17.

### 9. Modification of Laser Device (Fifth Embodiment)

FIG. 23 schematically illustrates a configuration of a main pulse laser device 3e used in an EUV light generation system according to a fifth embodiment. In the fifth embodiment, the main pulse laser device 3e may include a master oscillator 40c and a plurality of amplification systems PAS1, PAS2, and PAS3. Each of the amplification systems PAS1, PAS2, and PAS3 may include a pulse picker 76 and at least one amplifier PA.

The master oscillator 40c may include an actively mode-locked laser device or a passively mode-locked laser device. That is, the master oscillator 40c may be substantially the same as the master oscillator 40a shown in FIG. 17, or may be substantially the same as the master oscillator 40b shown in FIG. 22.

Abeam splitter 90a may be disposed in the optical path of a pulse laser beam outputted from the master oscillator 40c. The beam splitter 90a may transmit, toward the pulse picker 76 of the amplification system PAS1, a part of the pulse laser beam outputted from the master oscillator 40c and reflect another part. In this case, the reflected beam may be twice higher in intensity than the transmitted beam. Another pulse picker 760 may be disposed between the master oscillator 40c and the beam splitter 90a.

A beam splitter 90b may be disposed in the optical path of the pulse laser beam reflected by the beam splitter 90a. The beam splitter 90b may reflect, toward the pulse picker 76 of the amplification system PAS2, a part of the pulse laser beam reflected by the beam splitter 90a and transmit another part. In this case, the reflected beam and the transmitted beam may be substantially equal in intensity.

A high-reflecting mirror 90c may be disposed in the optical path of the pulse laser beam transmitted through the beam splitter 90b. The high-reflecting mirror 90c may reflect the pulse laser beam, transmitted through the beam splitter 90b, at high reflectance toward the pulse picker 76 of the amplification system PAS3.

In each of the amplification systems PAS1, PAS2, and PAS3, the pulse picker 76 may remove some pulses of the pulse laser beam so that the repetition frequency of the pulse laser beam may be, for example, 200 kHz. Further, a pulse laser beam passing through the pulse picker 76 of the amplification system PAS2 may lag behind the pulse laser beam passing through the pulse picker 76 of the amplification system PAS1 by 1.7 μs. A pulse laser beam passing through the pulse picker 76 of the amplification system PAS3 may lag behind the pulse laser beam passing through the pulse picker 76 of the amplification system PAS2 by 1.7 μs.

In each of the amplification systems PAS1, PAS2, and PAS3, the at least one amplifier PA may be disposed in the optical path of the pulse laser beam having passed through the pulse picker 76. The pulse laser beam amplified by passing through the at least one amplifier PA may be outputted from the corresponding one of the amplification systems PAS1, PAS2, and PAS3.

High-reflecting mirrors 91, 92, and 93 may be disposed in the optical paths of the pulse laser beams outputted from the amplification systems PAS1, PAS2, and PAS3, respectively. The high-reflecting mirrors 91, 92, and 93 may reflect the respective incoming pulse laser beams toward the optical path adjuster 94. The optical path adjuster 94 may focus, onto the plasma generation region 25, the respective pulse laser beams arriving from the high-reflecting mirrors 91, 92, and 93.

With this configuration, the optical path adjuster 94 may cause a pulse laser beam having a repetition frequency of 600 kHz to be focused onto the plasma generation region 25. Since a pulse laser beam having a repetition frequency of 200 kHz has been amplified in each of the amplification systems PAS1, PAS2, and PAS3, sufficient time may be ensured for laser gain recovery.

The above-described embodiments and the modifications thereof are merely examples for implementing the present disclosure, and the present disclosure is not limited thereto. It will be clear to those skilled in the art that making various modifications according to the specifications or the like is within the scope of the present disclosure, and other various embodiments are possible within the scope of the present disclosure.

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

1. An extreme ultraviolet light generation system comprising:
a chamber;
a target supply unit configured to supply, to a predetermined region in the chamber, a target having an atomic density of 8.0×10¹⁷ atoms/cm³ or higher and 1.3×10¹⁸ atoms/cm³ or lower; and
a laser apparatus configured to irradiate the predetermined region with a pulse laser beam having an energy density of 10.5 J/cm² or higher and 52.3 J/cm² or lower in the predetermined region.

2. The extreme ultraviolet light generation system according to claim 1, wherein the laser apparatus emits the pulse laser beam having an energy of 7.4 mJ or higher and 37 mJ or lower.

3. The extreme ultraviolet light generation system according to claim 1, wherein the laser apparatus emits the pulse laser beam having a pulse width of 1.0 ns or more and 3.7 ns or less.

4. The extreme ultraviolet light generation system according to claim 1, wherein
the laser apparatus emits the pulse laser beam at a repetition frequency of 500 kHz or higher, and
the target supply unit supplies the target at a velocity of 370 m/s or higher.

5. The extreme ultraviolet light generation system according to claim 1, wherein the target supply unit supplies a powder target.

6. An extreme ultraviolet light generation method comprising:
supplying, to a predetermined region in a chamber, a target having an atomic density of 8.0×10¹⁷ atoms/cm³ or higher and 1.3×10¹⁸ atoms/cm³ or lower; and
irradiating the predetermined region with a pulse laser beam having an energy density of 10.5 J/cm² or higher and 52.3 J/cm² or lower in the predetermined region.
